(19) United States
(12) Patent Application Publication
(10) Pub. No.: US 2002/0178038 A1
(43) Pub. Date: Nov. 28, 2002

(54) Institutional student tracking system

(76) Inventor: Donald R. Grybas, Bolingbrook, IL (US)

Correspondence Address: Welsh & Katz, Ltd., Richard J. Gurak, 22nd Floor, 120 South Riverside Plaza, Chicago, IL, 60606, US

(21) Appl. No.: 10/106,575

(22) Filed: Mar. 26, 2002

Related U.S. Application Data
(60) Provisional application No. 60/278,827, filed on Mar. 26, 2001.

(51) Int. Cl. G06F 17/60; G09B 19/00

(52) U.S. Cl. 705/7; 434/118

(57) ABSTRACT

An improved institutional student tracking system comprising in one form of the invention, a software system information that is divided into several modules that interact with each other to control student record management functions. In one embodiment, the system has a school module, a student module, a satisfactory academic progress module, a report module, a default management module, an attendance and grades module, and a utilities module. The system can also print a variety of reports such as performance reports, attendance reports, financial reports and other types of related reports. In alternate embodiments, the system can be accessed over the world wide computer network.

### CROSS REFERENCE TO RELATED APPLICATION

This application claims the benefit of U.S. Provisional Application No. 60/278,827 filed Mar. 26, 2001.

### FIELD OF THE INVENTION

The present invention relates to an institutional student tracking system, and more particularly to a user friendly software system for use by post secondary or other institutions to track student records.

### BACKGROUND OF THE INVENTION

Software systems to track student records of various types are known in the art. Such devices are typically used by schools or other institutions. Schools are commonly faced with the difficult task of collecting, storing, updating and productively using all of the student information available to the school. For example, classes need to be organized and scheduled, students need to have grades assigned and grade reports delivered, and student loans must be managed.

Previous software systems to track student records have some inherent disadvantages. One of the disadvantages with existing software systems to track student records is that they are cumbersome and difficult for a user to learn and use. They are also limited to programs that are Microsoft ® DOS based and are not available for use over the world wide computer network. Many existing systems are greatly limited by or have no marketing analysis capability. Also, existing systems are not easy to work with when generating reports based on the student data. They lack extensive holiday tracking capability and grading scales to record letter grades.

Another disadvantage is that they do not provide for student progress reports for students who change rates of attendance. Further, existing systems have limited or no placement tracking capability and limited or no student loan default management capability.

The present invention overcomes these and other problems inherent in existing software systems to track student records. The present invention provides an institutional student tracking system that uses a user friendly software system for use by post secondary or other institutions to track student records. The system is divided into several modules which may include a school module, a student module, a satisfactory academic progress module, a report module, a default management module, an attendance and grades module, and a utilities module. In one embodiment, the system is Windows ® based but other embodiments may be based in other operating systems.

The principal object of the present invention is to provide an improved software system for use by post secondary or other institutions to track student records.

Another object of the present invention is to provide a novel software system for use by post secondary or other institutions to track student records which comprises a system divided into several modules that interact with each other to control all student record management functions.

Still another object of the present invention is to provide a novel software system for use by post secondary or other institutions to track student records which has a school module, a student module, a satisfactory academic progress module, a report module, a default management module, an attendance and grades module, and a utilities module.

A further object of the present invention is to provide a novel software system for use by post secondary or other institutions to track student records that can generate standard and user defined reports.

A further object of the present invention is to provide a novel software system for use by post secondary or other institutions to track student records that can be used by institution employees and student over the world wide computer network.

A further object of the present invention is to provide a novel software system to track student records which is simple in design and inexpensive to construct, and is durable and rugged in structure.

Still further objects and advantages will become apparent from a consideration of the ensuing description and drawings of the invention.

These and other objects are achieved by a software system for use by post secondary or other institutions to track student records of the present invention. In one form of the invention, an institutional student tracking system (ISTS) is provided which comprises a software system divided into several modules that interact with each other to control all student record management functions. In one embodiment, the system may have a school module, a student module, a satisfactory academic progress module, a report module, a default module, an attendance and grades module, and a utilities module. The ISTS main menu displays these modules when the system is accessed. Upon accessing the system, a main menu will be displayed showing the seven administrative modules available as well as an “exit” command button. Below these eight command buttons, the screen will display the name, address, and phone numbers of the institution. At the bottom of the main menu, the day and date are displayed, and the version number of the system that is running.

### BRIEF SUMMARY OF THE INVENTION

The institutional student tracking system (“ISTS”) responds to the overwhelming need for a user friendly, year 2000 compliant software system for use by post secondary or other institutions to track student records.

The ISTS provides institutions with a state of the art system to monitor students' progress from their first interest in an institution, through the placement of those student graduates in the occupations for which they trained. An institution will have rapid and easy access to a prospective student's status, an enrolled student's academic progress, and accounts receivable information, as well as alumni placement information, and even student loan borrower's default management records.

Beyond basic student record tracking, the ISTS performs other invaluable school management functions. Institutions will have immediate access at their computers, monitors or other electronic data input and viewing device to every subject offered by the institution, every program of study offered by the institution, complete marketing performance reports on each admissions representative institutions employ, and a perpetual analysis of which types of advertising are best serving student recruitment needs. Institutions will also benefit from a daily schedule report identifying every prospective student who is scheduled for a consultation appointment, enrollment appointment or financial aid appointment on any date selected. And, the ISTS's document tracking reports provide an institution with an “at a glance” view of what important documents may be missing from a student's file. In addition, institutions get a variety of financial reports covering everything from complete outstanding receivables listings, to 90-10 calculations and unearned tuition summaries. These reports can be generated quickly when audit time arrives. The ISTS has been designed to take the burden away from student records administration.

In one embodiment, the ISTS software system is divided into several modules that interact with each other to control all student record management functions. Upon accessing the system, a main menu will be displayed showing the several modules available. The screen may also display the name, address, and phone numbers of the institution. Also, the main menu may display the day and date, and the version number of the system that is running. The system may control information based on specific dates, such as attendance, grades, or accounts receivable.

The School module contains all of the global information about the institution. In this module information is entered such as basic demographic information about the school, all of the subjects/courses offered by the school, and the academic programs offered by the school. Beyond curriculum information, the school module also contains databases of admissions employees, the types of advertising used to attract students, employers with whom student graduates are placed, and a school holiday calendar. Once all of the global information has been loaded into the School module, an institution will only have to revisit the School module if making changes to any of this global information. For example, if adding a new program, editing admissions employees, or modifying school holidays, these functions would be performed in the school module.

The student module contains all student data from prospective student information through placement of that student after graduation. The student module is comparable to a complete file of the student's history at the institution. The student module enables an institution to add new students to its system, record attendance and grades for students, post accounts receivable data, as well as many other features.

The satisfactory academic progress (SAP) module has been designed to provide an institution with the ability to run satisfactory progress reports. This module will extract attendance and grade information from the student record to determine whether or not he/she is making satisfactory progress. The module also provides for reports. One report represents a summary listing of all students' data extracted from the system. This report is designed for the school's use. The second type of report is commonly referred to as a report card. This student specific report contains all of the student's attendance and grade history, with explicit statements on whether or not the student is meeting satisfactory progress standards. SAP reports can be run based on any date range selected, as well as on any attendance interval selected, i.e., all students who should have completed a certain number of attendance hours.

Although SAP reports are generated from the SAP module, the system's global report capability is also obtained through the report module. In this module a user may print a variety of reports from lists of all data loaded into the school module to admissions representative performance reports, periodic attendance reports, all financial reports, and accrediting agency annual reports.

The ISTS's default management module is designed to aid schools in both its in-house default prevention responsibilities, as well as with any outside default management service the institution elects to employ. The default management module contains loan information for student borrowers, their references, and loan repayment status. The ISTS can produce grace period letters to students at 30, 90, and 150 days intervals into their grace period. Once in repayment, a 30-day repayment letter is produced further advising students of their loan obligations. Finally, delinquent letters, as well as letters to the student borrower's references, can be produced to pursue default prevention.

Finally, once the loan status and date information have been recorded in the ISTS, the user will be able to generate a complete cohort default rate (CDR) calculation months before the pre-published and official CDR's are received from the Department of Education.

The ISTS gives options for recording student attendance and grade information. Users can post attendance and grades on the individual student record from within the student module, or they can post this data from the attendance/grades module.

This module has been designed to easily select a particular student from a pick list rather than exiting out to the select student screen in the student module. However, a user will still be able to view and enter attendance and grade information from within an individual record in the student module.

If an electronic time clock is used to record daily attendance information, this data can be imported into the ISTS. Since there are a number of different time clock manufacturers, the system can be configured with the export file specifications of the specific time clock software.

The utilities module serves functional and troubleshooting purposes. On the functional side, one use will be to edit a particular student's social security number. In some cases, students might be unwilling to provide institutions with their social security number when they are first inquiring about the institution. ISTS records students' information when they first become a prospect at the school. If at that time, a user is creating a student record without a valid social security number (SSN), the ISTS will assign a temporary SSN. At a later date, the user would use the utilities module to edit the student's SSN, and convert it to the actual SSN of the enrolling student.

In terms of troubleshooting, there are also additional features in the utilities module. One feature will delete all student records in the system. This feature is primarily intended for some users that want to experiment with the system for a period of time with dummy records before they are ready to load actual student data. In these cases, the delete utility will empty the database and let the user start from the beginning with no data. In one form, the delete function requires a password. It is impossible for anyone to run this utility without first having the password. Finally, an accounts receivable balancing utility is available which can be periodically executed to ensure accurate receivables balances if a student record should somehow become corrupt.

### BRIEF DESCRIPTION OF THE DRAWINGS

FIG. 1 shows the institutional student tracking system's main menu;

FIG. 2 shows the institutional student tracking system's school module with the general tab selected;

FIG. 3 shows the institutional student tracking system's school module with the subjects tab selected;

FIG. 4 shows the institutional student tracking system's school module with the programs tab selected;

FIG. 5 shows the institutional student tracking system's select courses module showing the select courses screen;

FIG. 6 shows the institutional student tracking system's school module with the admissions reps tab selected;

FIG. 7 shows the institutional student tracking system's school module with the lead sources tab selected;

FIG. 8 shows the institutional student tracking system's lead sources list;

FIG. 9 shows the institutional student tracking system's school module with the employers tab selected;

FIG. 10 shows the institutional student tracking system's school module with the holidays tab selected;

FIG. 11 shows the institutional student tracking system's select student screen of the student module;

FIG. 12 shows the institutional student tracking system's student module with the general tab selected;

FIG. 13 shows the institutional student tracking system's student module with the prospect tab selected;

FIG. 14 shows the institutional student tracking system's student module with the tracking tab selected;

FIG. 15 shows the institutional student tracking system's student module with the enrollment tab selected;

FIG. 16 shows the institutional student tracking system's review enrollment status screen of the student module;

FIG. 17 shows the institutional student tracking system's student module with the attendance tab selected;

FIG. 18 shows the institutional student tracking system's student module with the grades tab selected;

FIG. 19 shows the institutional student tracking system's student module with the accounts receivable tab selected;

FIG. 20 shows the institutional student tracking system's student module with the placement tab selected;

FIG. 21 shows the institutional student tracking system's satisfactory academic progress module;

FIG. 22 shows the institutional student tracking system's reports module;

FIG. 23 shows the institutional student tracking system's default management module;

FIG. 24 shows the institutional student tracking system's default management module for a selected student with the general student information tab selected;

FIG. 25 shows the institutional student tracking system's default management module for a selected student with the loan information tab selected;

FIG. 26 shows the institutional student tracking system's default management module for a selected student with the references tab selected;

FIG. 27 shows the institutional student tracking system's letters list;

FIG. 28 shows the institutional student tracking system's attendance and grades module with the bulk posting mode tab selected;

FIG. 29 shows the institutional student tracking system's attendance and grades module with the view selected student detail tab selected;

FIG. 30 shows the institutional student tracking system's attendance and grades module with the import attendance from electronic clock tab selected;

FIG. 30A shows the institutional student tracking system's time clock import mode;

FIG. 31 shows the institutional student tracking system's utilities module;

FIG. 32 shows a Satisfactory Academic Progress Summary Report of the ISTS;

FIG. 33 shows a Student Academic Progress Report Card;

FIG. 34 shows one page of a Course/Subject Listing Report;

FIG. 35 shows one page of a Program Listing Report;

FIG. 35A shows an alternate page of a Course/Subject Listing Report;

FIG. 36 shows an Admissions Representative Listing Report;

FIG. 37 shows an Employers Listing Report;

FIG. 38 shows a Holiday Listing Report;

FIG. 39 shows an Admissions Representative Performance Report (All Contact Dates Included);

FIG. 40 shows an Admissions Representative Performance Report (Based on Initial Contact Date Range);

FIG. 41 shows a Lead Source Performance (All Contact Dates Included);

FIG. 42 shows one page of a Lead Source Performance (Based on Initial Contact Date Range);

FIG. 42A shows an alternate page of a Lead Source Performance (Based on Initial Contact Date Range);

FIG. 43 shows an Attendance Report by Date;

FIG. 44 shows a Periodic Attendance Report;

FIG. 45 shows one page of an Attendance Report by Date;

FIG. 46 shows an Enrollment Report;

FIG. 47 shows a Scheduled Appointments by Type Report;

FIG. 48 shows a Tuition Payments Report;

FIG. 49 shows a 90-10 Calculation Report;

FIG. 50 shows a Student Accounts Receivable Summary;

FIG. 51 shows an Accounts Receivable Balance Summary;

FIG. 52 shows a Student Accounts Receivable Summary;

FIG. 53 shows an Unearned Tuition Report;

FIG. 54 shows a Scheduled Appointments by Date Report;

FIG. 55 shows a Monthly Attendance and Hours Report;

FIG. 56 shows a Document Tracking Report;

FIG. 57 shows a Student Placement Information Report;

FIG. 58 shows an Attendance Report Sorted by Date Report;

FIG. 59 shows a Periodic Attendance Report;

FIG. 60 shows an Enrollment Report;

FIG. 61 shows the first page of an Annual Report Section I;

FIG. 61A shows the second page of an Annual Report Section I;

FIG. 62 shows the first page of an Annual Report Section II;

FIG. 62A shows the second page of an Annual Report Section II;

FIG. 63 shows an alternate embodiment of a Program Listing Report for term based institutions;

FIG. 64 shows the first page of an Annual Report Section III;

FIG. 64A shows the second page of an Annual Report Section III;

FIG. 65 shows an alternate embodiment of the institutional student tracking system's attendance and grades module with the view select student detail mode selected;

FIG. 66 shows an alternate embodiment of the institutional student tracking system's student module with the accounts receivable mode selected;

FIG. 67 shows an alternate embodiment of the institutional student tracking system's school module with the term calendar mode selected;

FIG. 68 shows an alternate embodiment of the institutional student tracking system's student module with the enrollment mode selected;

FIG. 69 shows an alternate embodiment of the institutional student tracking system's student module with the transfer mode selected;

FIG. 70 shows an alternate embodiment of the institutional student tracking system's student module with the registration mode selected;

FIG. 71 shows an alternate embodiment of the institutional student tracking system's school module with the grade scale mode selected;

FIG. 72 shows an alternate embodiment of the institutional student tracking system's school module with the service mode selected;

FIG. 73 shows an alternate embodiment of the institutional student tracking system's student module with the service mode selected;

FIG. 74 shows an alternate embodiment of the institutional student tracking system's student module with the accounts receivable mode selected;

FIG. 75 shows an alternate embodiment of the institutional student tracking system's attendance and grades module with the bulk posting mode selected;

FIG. 76 shows an alternate embodiment of the institutional student tracking system's attendance and grades module with the view select student detail mode selected;

FIG. 77 shows a letter to employers of school graduates generated by the institutional student tracking system;

FIG. 78 shows an Accounts Receivable Transaction Receipt generated by the institutional student tracking system;

FIG. 79 shows a first page of a Student Academic Progress Report Card for term based schools generated by the institutional student tracking system;

FIG. 80 shows a first page of a Student Academic Progress Report Card for clock based schools generated by the institutional student tracking system;

FIG. 80A shows a second page of a Student Academic Progress Report Card for term based schools generated by the institutional student tracking system;

FIG. 81 shows one form of a student loan default prevention letter generated by the institutional student tracking system;

FIG. 82 shows another form of a student loan default prevention letter generated by the institutional student tracking system;

FIG. 83 shows a schematic view of a flow chart for one embodiment of the ISTS;

FIG. 84 shows a schematic view of a flow chart for one embodiment of a school module;

FIG. 85 shows a schematic view of a flow chart for one embodiment of a student module; and

FIG. 86 shows a schematic view of a flow chart for alternate embodiment of a computer network of the present invention.

### DETAILED DESCRIPTION OF THE INVENTION

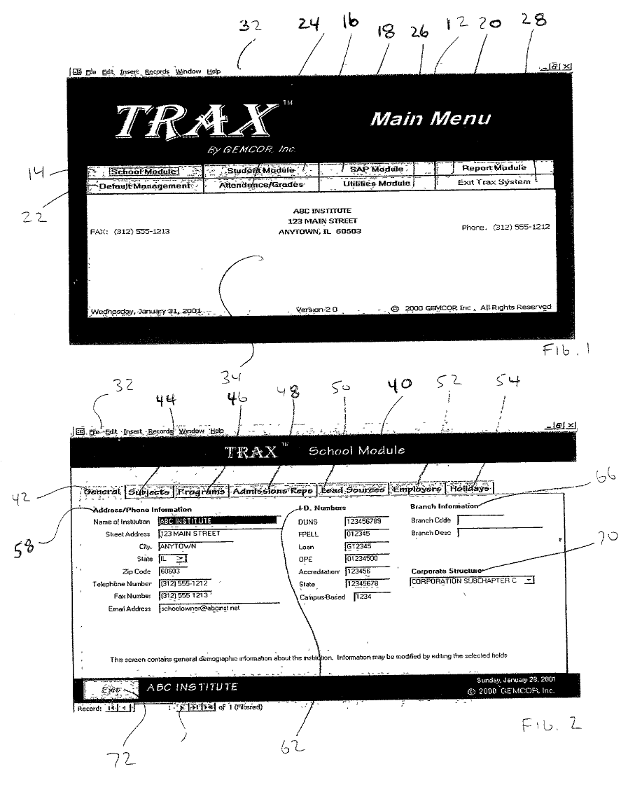

FIG. 1 shows the institutional student tracking system's main menu screen. In one form as shown in FIG. 1, the main menu 12 has seven administrative modules accessed by a school module button 14, a student module button 16, a satisfactory student progress (SAP) module button 18, a report module button 20, a default management module button 22, an attendance/grades module button 24, a utilities module button 26 and an exit system button 28. Also, the main menu 12 as well as any other screens of the institutional student tracking system may have a menu bar 32. Further, the main menu 12 may have an information area 34 that has the name, address, phone numbers of the institution, the day and date, and the version number of the system that is running. In one embodiment, the system is Windows ® based but other embodiments may be based in other operating systems.

### The School Module

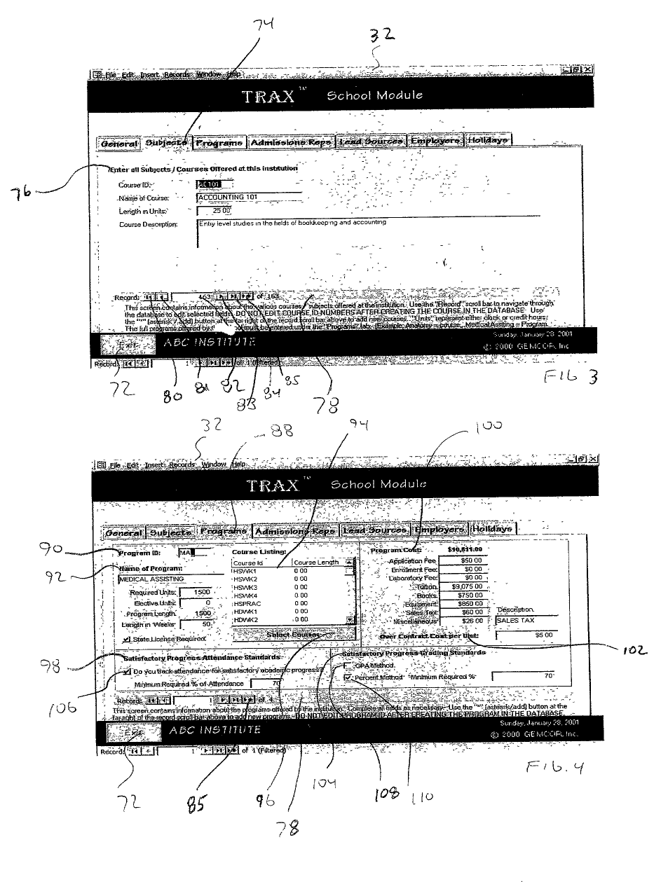

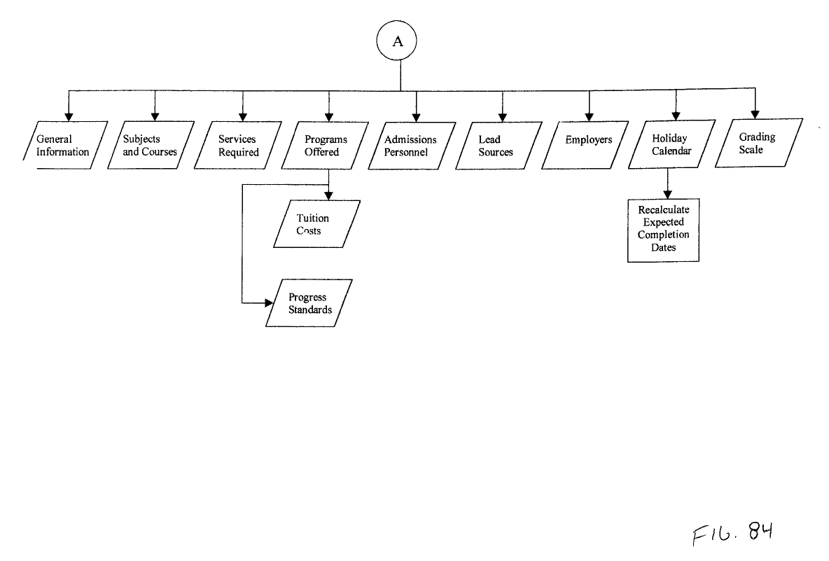

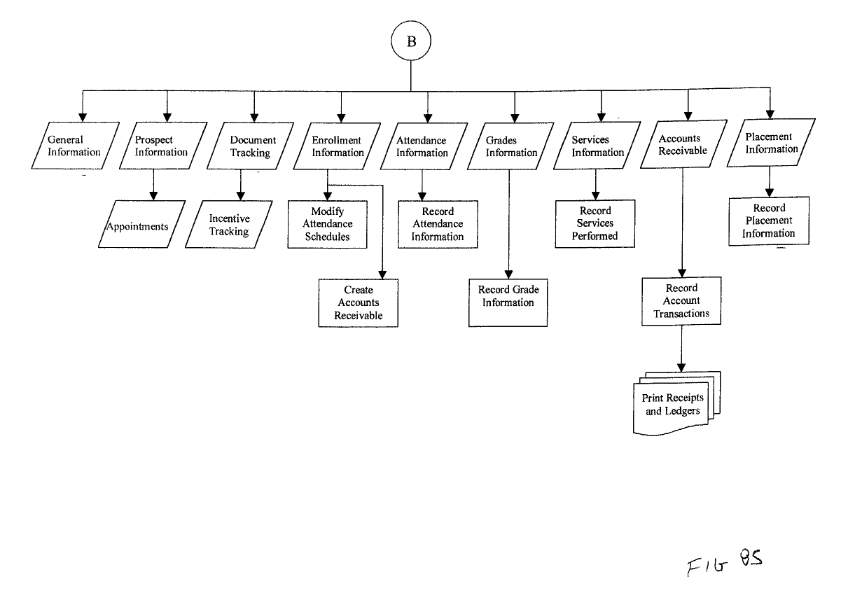

FIG. 2 shows one form of the institutional student tracking system's 10 school module with the general tab selected. FIGS. 83 and 84 show a schematic view of a flow chart for one embodiment of the school module 40. The school module 40 may have seven sub-tables, each containing data relative to the institution's structure. In one form, each of the School module's 40 sub-tables and its related functions may be as follows.

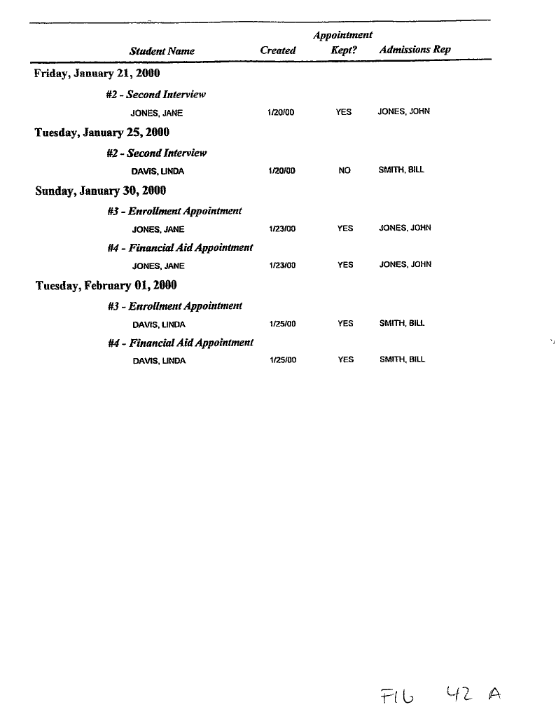

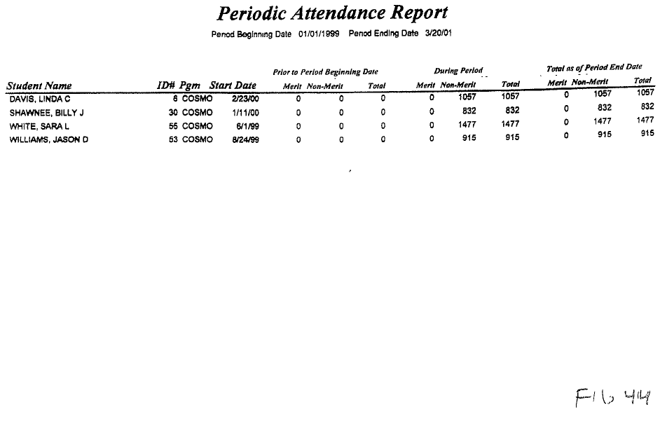

As shown in FIG. 2, the general tab 42 of the school module 40 may display basic demographic information about the institution. An address and phone information area 58 may be shown, followed by a relevant ID numbers area 62, a branch information area 66 and/or corporate structure information area 70. In one form, most of this information will remain constant throughout the life of the institution, but may be edited at any time from within the school module 40. A user may use the [tab] or [enter] key of the user's keyboard or other data entry device to navigate through this screen as the institution's general information is entered. Further, an exit button 72 may be provided on this screen 40 or on any other screen of the institutional student tracking system. In one embodiment, a variety of different reports may be generated from the school module 40 or by other modules of the ISTS such as for example reports shown in FIGS. 35, 35A, 36, 37 and 38.

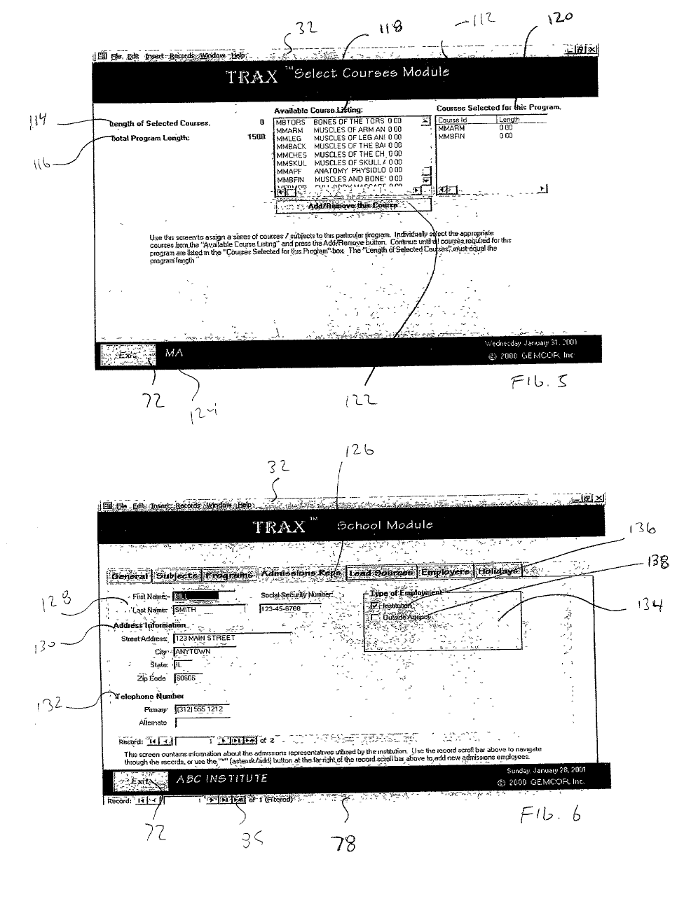

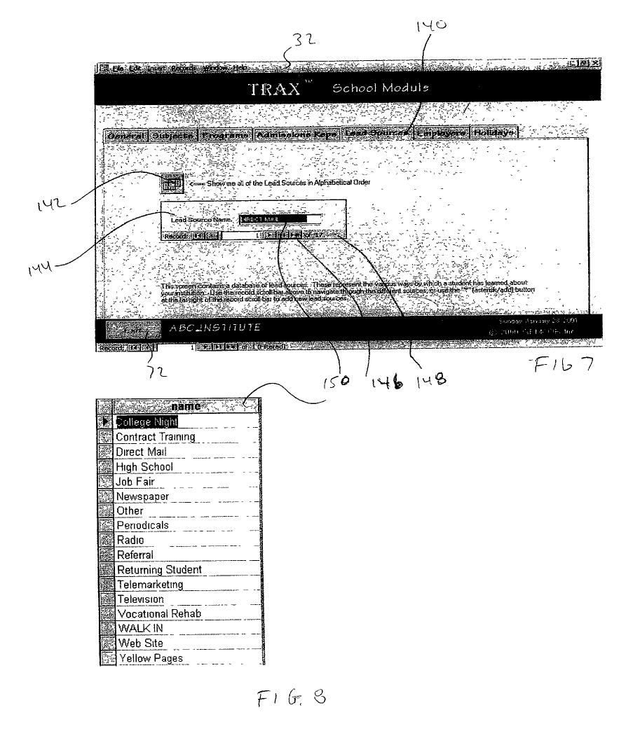

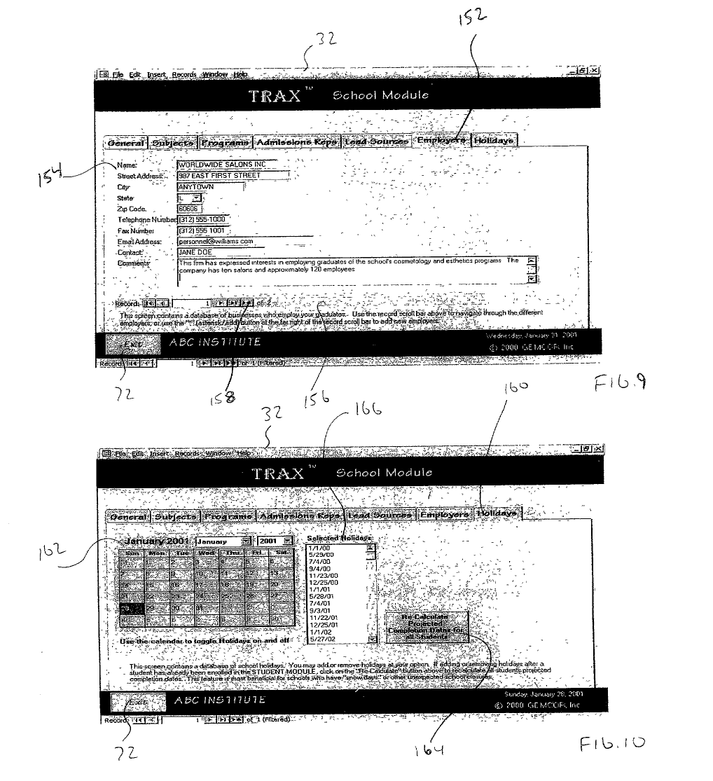

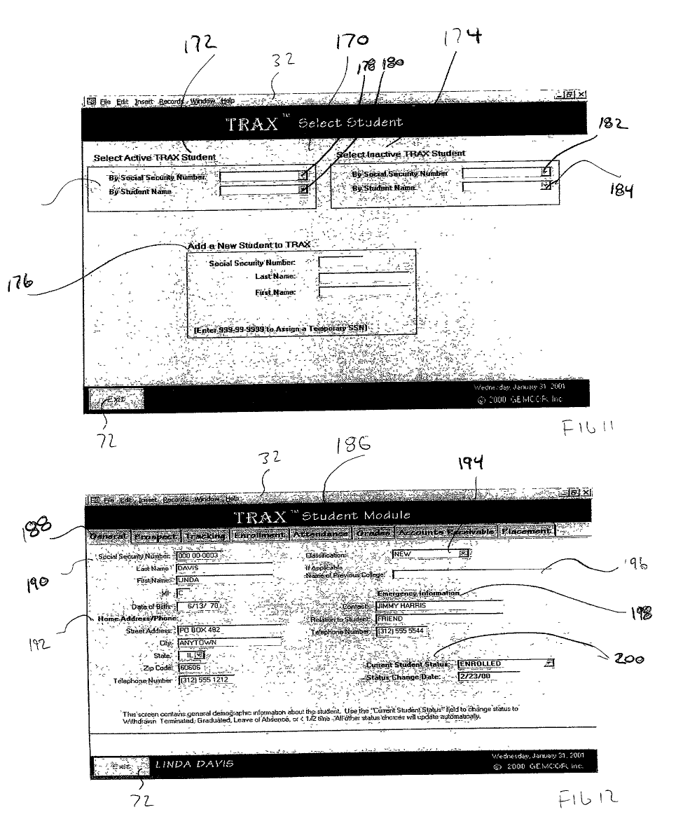

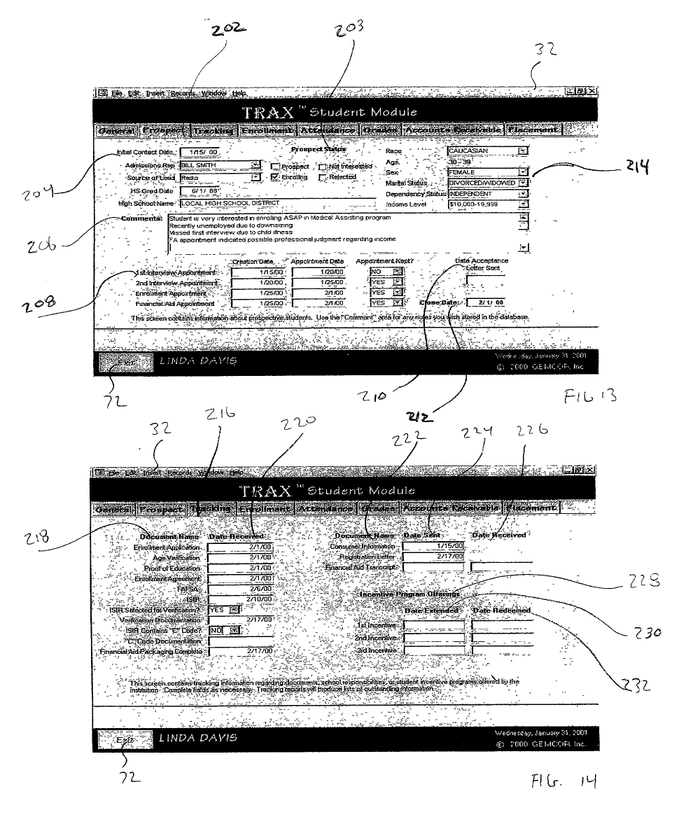

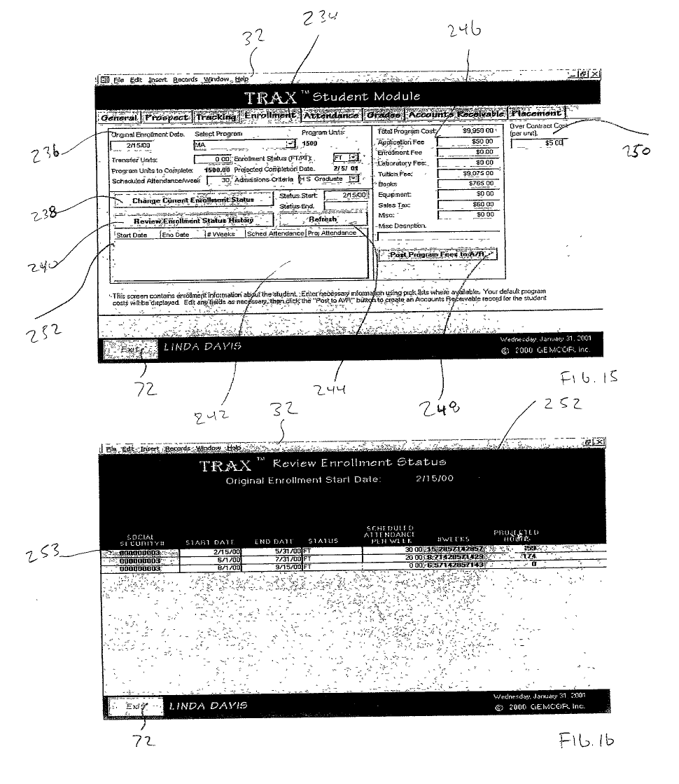

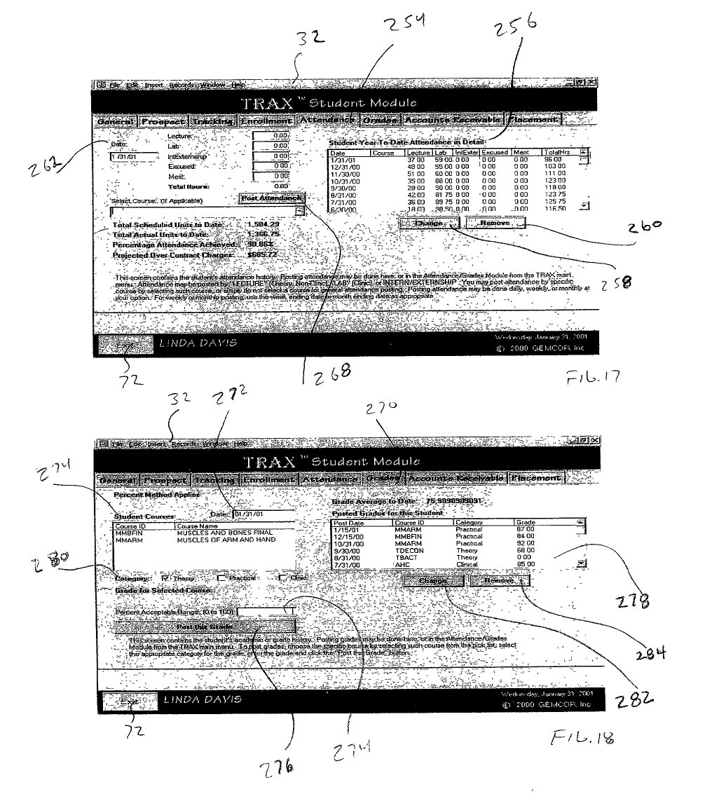

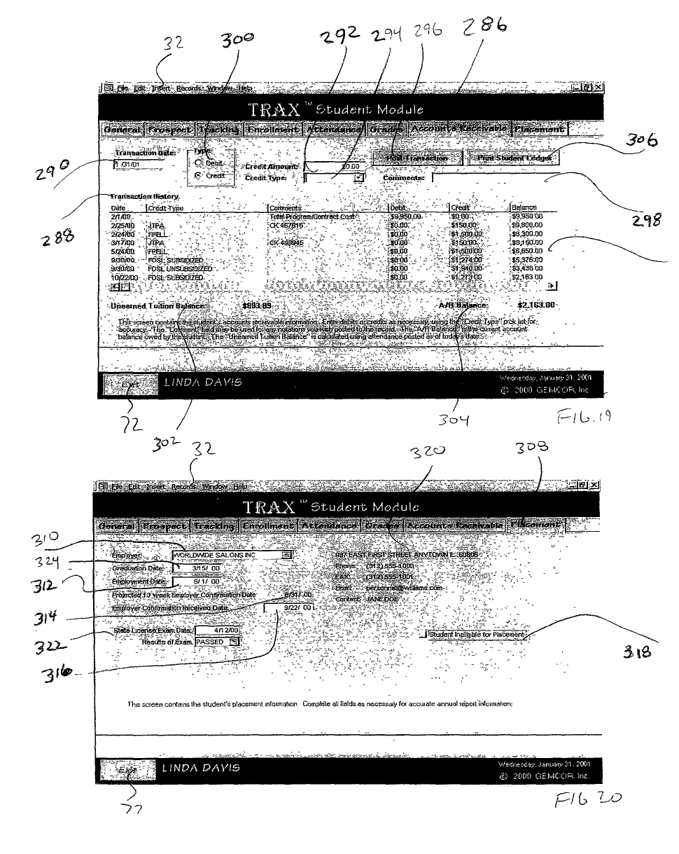

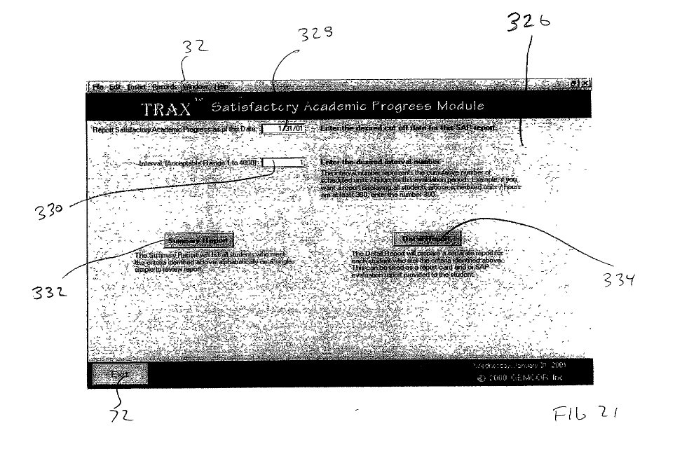

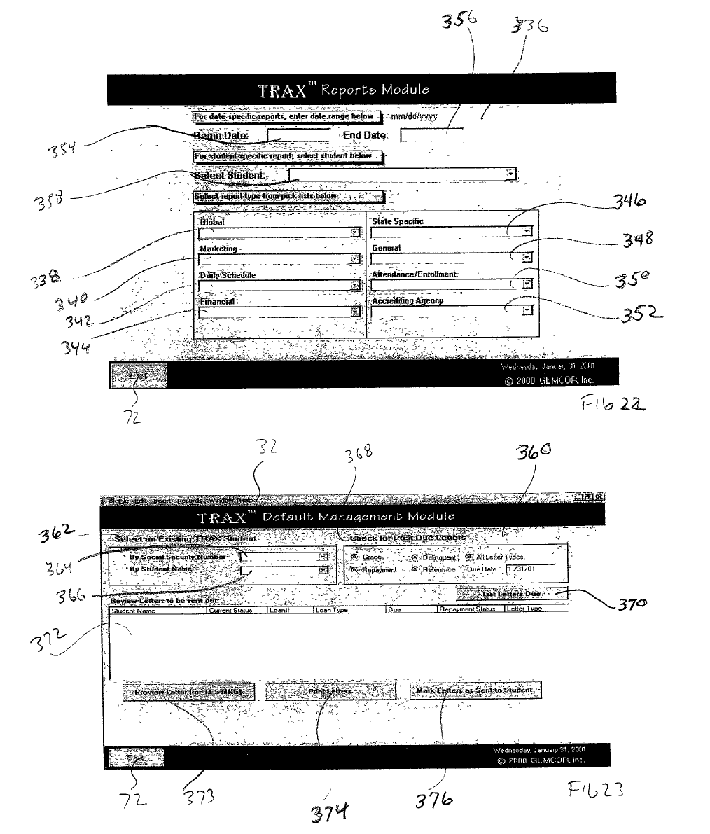

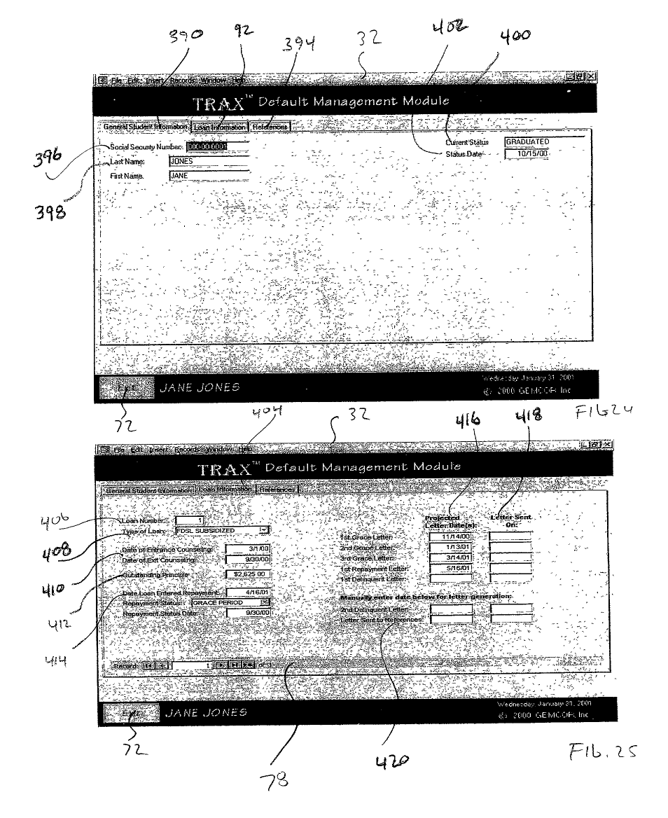

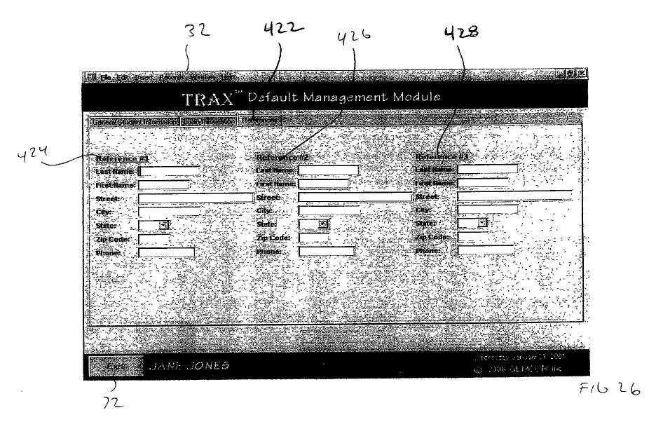

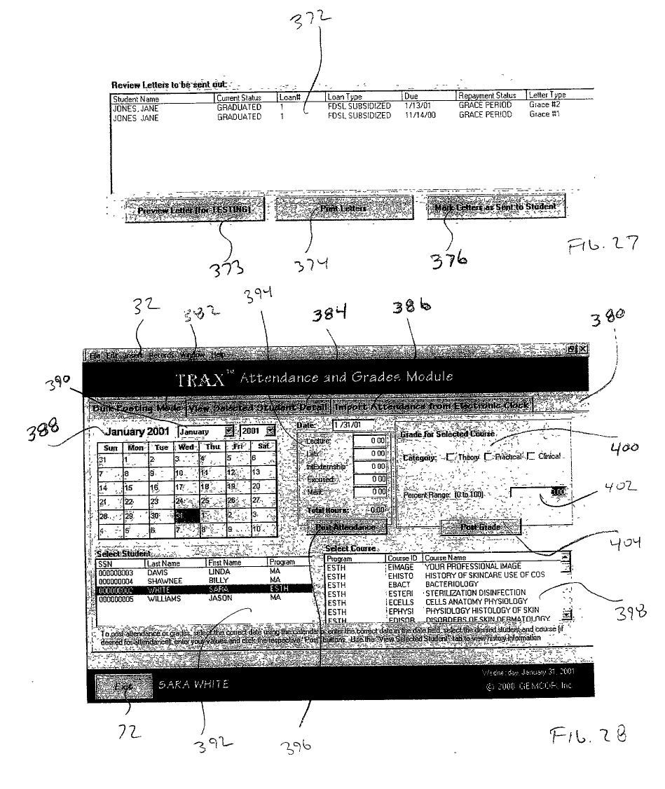

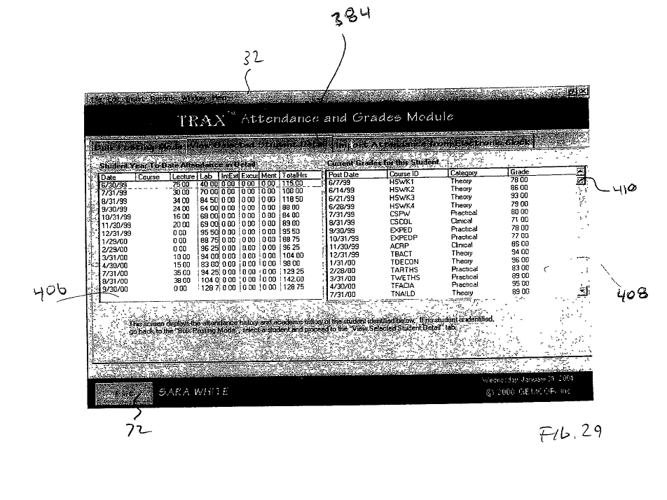

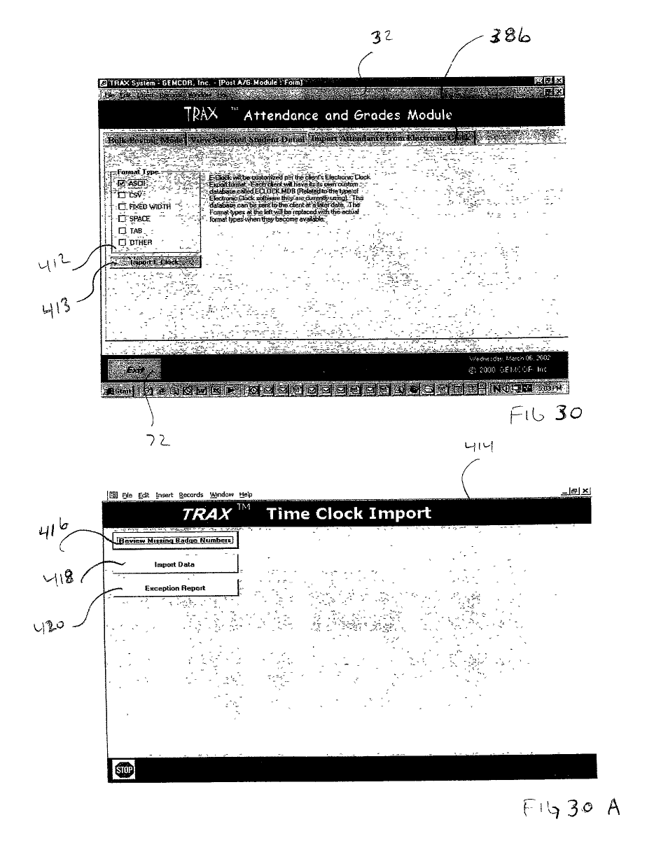

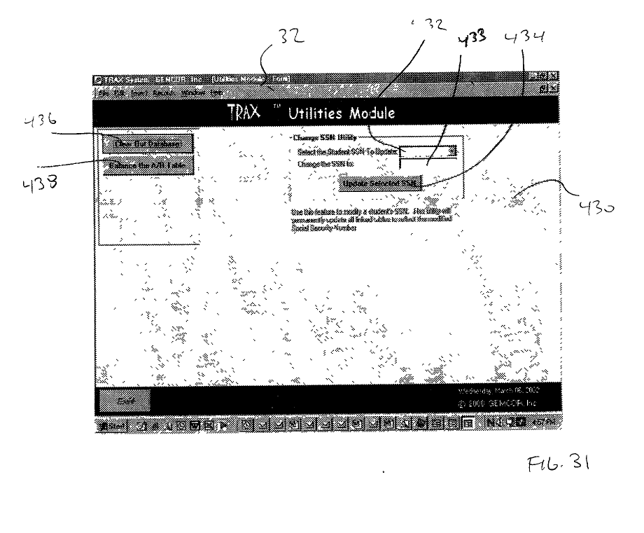

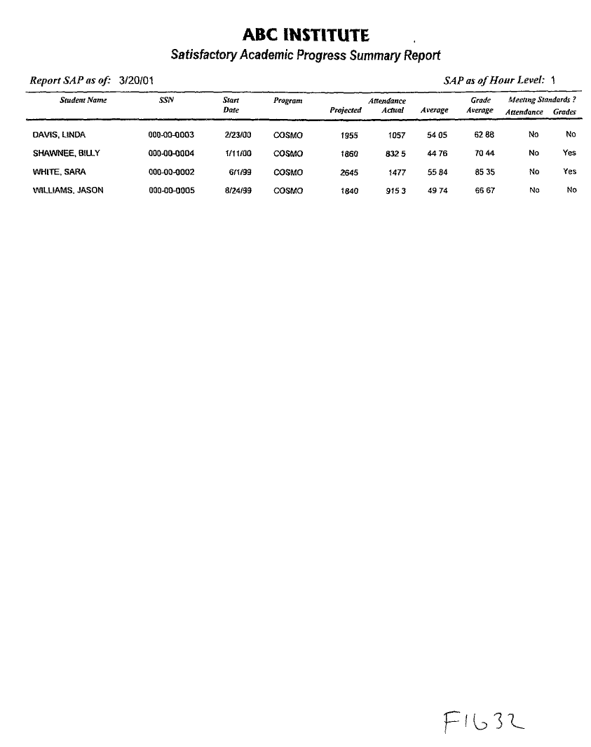

FIG. 3 shows one form of the institutional student tracking system's school module with the subjects tab selected. The subject tab 74 of the school module 40 provides access to a database and or list of all individual subjects, or courses, offered by the institution. Subjects are defined as individual educational elements, or classes, required to be completed by the student as he/she advances toward graduation from a particular program. For example, Word Processing 101, Bookkeeping 101, and Typing 201 would all be considered subjects, or courses, necessary for graduation from an institutions office specialist program.

As shown in FIG. 3, the subject tab 74 may contain a subjects/courses information area 76. Area 76 provides information for a variety of different subjects offered by the institution such subjects may contain information such as a course ID; the name of the course; the length of the course in units; and a course description. (“units” is a universal term covering both clock and credit hours). For example, a 25 clock hour course would have a length of 25 units, while a 4 credit hour course would have a length of 4 units.

A record scroll bar 78 allows the user to both navigate through the subjects/courses in the database or list, as well as add new subjects. In FIG. 3, the record scroll bar 78 indicates that the Accounting 101 Course is the 163^{rd} subject of a total of 163 subjects in the database or list. As such, it was the most recent subject added by the institution to the system. In one form of the ISTS the record scroll bar 78 serves a similar purpose throughout the ISTS. The record scroll bar may have buttons 80, 81, 83-85 and field 82. Button 80 moves to the first record of the current database of records, button 81 moves backwards in one record increments, field 82 displays record number of record being viewed, button 83 moves forwards in one record increments, button 84 moves to the last record of the current database of records and button 85 adds a new record to the current database of records.

To add or edit subject or courses, the user must enter the school module 40 and select the subject tab 74 to access the database of subjects/courses at the institution. When the user initially sets up the system, the first record in the subjects database (record #1) will be blank. Although a course description is optional, the user enters a course ID, name, and length for all subjects/courses entered into the database.

### Course ID

A course ID can be up to six characters in length and should be reasonably identifiable. In other forms, the course ID can be longer than six characters. Student report cards and course grades are identified with a course ID, rather than by course name. An example of a course ID for word Processing 101 would be WP101. The subjects/courses entered into the ISTS are indexed and linked by course ID number. In one form, course ID's may not be changed after they have been established. The user may, however, edit course names, lengths, and descriptions after the course record has been loaded. A user may use the [tab] or [enter] keys of the users keyboard or other device to proceed to the next field.

### Name of Course

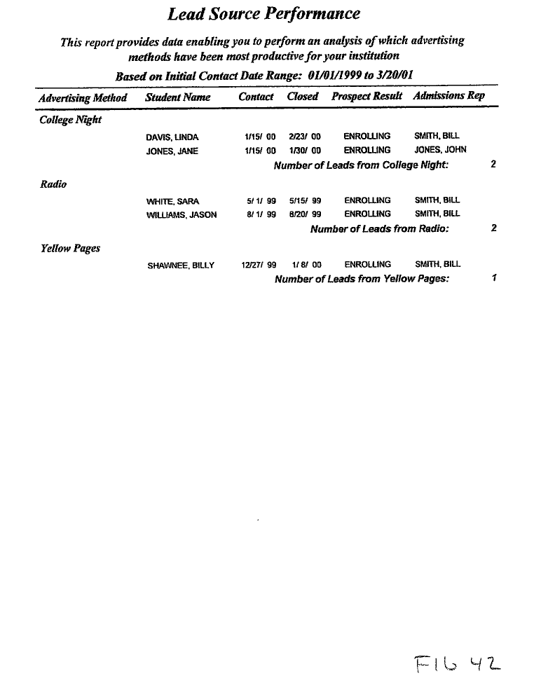

The user may enter the name of the subject/course that the user is loading into the system. A course listing report (see for example FIG. 34) will provide a hard copy printout of all course data entered into the system. This can be a useful tool for cross-referencing course ID's with names, lengths, etc. at a later date.

### Length in Units

The length of a particular subject/course may be measured in a universal term called “units”. A unit can be either a clock hour or credit hour. For example, if the institution offers a 900 hour medical assisting program, and one of the subjects/courses in that program is a 48 hour anatomy course, the length in units of the anatomy course would be 48. When the user loads each of the programs offered at its institution, the sum of the units of all courses pertaining to a particular program must equal the program's length in units.

### Course Description

The course description may be entered by a user and may be a short or a lengthy description of that particular subject matter. At this point, the user has now successfully added a course to the database. The user may add another subject/course, by selecting the add a record button 85 of the record scroll bar 78. The record number will increase by one, and a blank screen will be available to add another subject. The user may continue until all subjects have been added to the system. The user may edit an existing record by scrolling through the records using the record scroll bar 78 until the record the user wishes to edit is displayed.

FIG. 4 shows the institutional student tracking system's school module with the programs tab selected. The programs tab 88 of the school module 40 contains a database or list of all academic programs offered by the institution. A program is defined as a combination of subjects/courses in a specific field of study for which the student will receive a certificate, diploma, or degree. Example: “Cosmetology” would be referred to as a “program” with required subjects/courses including anatomy, skin care, and health & public safety.

The programs tab screen 88 may contain a variety of different information. Screen 88 may show basic information about the particular program record selected. This information may include a program ID area 90; a name of program area 92 specifying units required for graduation; and a course listing area 94 indicating all required subjects/courses necessary for completion of this program of study.

A program cost area 100 may be provided that indicates the default cost components for the specific program, including a provision for any per unit fees the institution may charge the student if he/she fails to complete the program by the projected completion date as identified in the over contract costs area 102. These cost elements reflect the charges for the specific program. They can be used when enrolling new students, and creating a new accounts receivable record. Should a students charges be different from the published cost for the entire program, e.g., if a student is transferring in credit, the cost elements may be edited from within the student module when the user is creating the new student record.

Further, an institution's satisfactory attendance standards area 98 for a specific program may be available. This percentage standard may be used to determine satisfactory attendance achievement for students enrolled in a specific program of study. The programs screen 88 may also contain an institution's satisfactory academic standards area 104 for a specific program using either grade point average (GPA) or percentage measurement. This standard will be used to determine satisfactory academic achievement for students in a specific program of study. A record scroll bar may also be provided and used in the same manner as described above.

To add or edit programs, the user enters the school module 40 and selects the programs tab 88 to access the database or list of programs offered at the institution. When the user is initially setting up its system, the first record in the programs database or list (record #1) will be blank.

### Program ID

A program ID may be up to six characters in length and should be reasonably identifiable. In other forms, the program ID may be more than six characters in length. Many of the reports generated reflecting a program of study will display this ID. Examples of program ID's for the “Medical Assisting” program would be “MA” or “MEDAST”

The programs entered into the ISTS are indexed and linked by program ID number. The user may edit information within the program screen after the program record has been loaded. A user may use the [tab] or [enter] key of the users keyboard or other device to proceed to the next field.

### Name of Program

A user may enter the name of the program of study into the system. A program listing report will provide a hard copy printout of all program data entered into the system. This can be a useful tool for cross-referencing program ID's with required courses, costs, etc.

### Program Length in Units and Weeks

Although most programs' lengths are fully made up of required units, the system offers an option of including elective units if this is relevant for the institution. The user can enter the number of required units and any elective units in the fields provided in the name of program area 92. The sum of the required and elective units equals the program's length. For example: A medical assisting program made up of 900 clock hours of required elements, would have 900 required units and zero elective units. If the same program had only 750 hours of required subjects, and the student could choose his/her remaining 150 hours from a variety of different courses, then this scenario would indicate 750 required units and 150 elective units.

### Satisfactory Progress Attendance Standards

The satisfactory information progress attendance area 98 may have a check box 106. The satisfactory progress attendance standards value is used in the SAP module (see FIG. 21) for determining student satisfactory academic progress. If the institution is tracking attendance for SAP, the check box 106 should be selected. A check mark will appear in the check box 106 indicating that the institution tracks attendance. The user may then enter the minimum required attendance percentage relative to the specific program. For example: If the attendance requirement is 67%, the user would enter the value 67

### Satisfactory Progress Grading Standards

The satisfactory progress grading standards area may have a GPA method check box 108 and a percent method check box 110. The satisfactory progress grading standards value is also used in the SAP module (See FIG. 21) for determining student satisfactory academic progress (SAP). Two options are available regarding the measurement of grading standards, the grade point average (GPA) method, and the percentage method. The method chosen must correspond to the manner in which student exams are graded. A user may choose the appropriate method as the grading standard by selecting the corresponding check box 108 or 110. A check mark will appear indicating the choice. The user may then enter the minimum value necessary for the student to maintain satisfactory progress. For example: If percentage grade requirement is 75%, enter the value 75; GPA methods are based on a standard 1.0 to 4.0, or 1.0 to 5.0 scale.

### Program Costs

The program costs area 100 contains the current default costs for the specific program record. These values will be obtained by the system when enrolling a new student and creating an accounts receivable record. The user will have the opportunity to edit these values in the student record before creating the accounts receivable record. After entering current program costs in the fields provided, they will remain constant until modifying the fees associated with the program, and editing the program record at that time.

As the user enters the values in the related cost fields, the total program cost at the top of the screen will adjust accordingly. If a bold type program cost is not displayed at the top of the cost list, a necessary value is null. A user would enter $0.00 for any field that does not have an associated cost. If a field is blank, and the total program cost is not displayed at the top of the cost list, student's accounts receivable records will not reflect the actual charge incurred by them.

### Course Listing

The course listing area 94 will display all subjects/courses required for a specific program of study. When adding a new program to the ISTS, course listing area 94 will be empty until the user selects the appropriate courses relative to the specific program. Proper selection of a program's related courses will ease the burden of posting grades to the student record. For example, when posting grades to a medical assisting student record, only the courses related to medical assisting are displayed. This eliminates the need to search through the entire database or list of unrelated courses to find the anatomy course for example. A select courses button 96 may be provided. To select the courses relative to the specific program the user selects the select courses button 96.

### Available Course Listing

FIG. 5 shows one form of the institutional student tracking system's select courses module showing the select courses screen 112. An available course listing area 118 will display all subjects/courses that the user previously entered in the subject tab 74 of the school module 40 and will contain every individual subject/course in the database or list. As shown in FIG. 5, courses selected for this program area 120 will display only those that the user has selected as a part of the specific program. The program ID is displayed at the bottom left corner of the screen in the program ID area 124.

A user can select a particular subject/course to be registered as an element of this program, by selecting the course from within the available course listing area 118. The selected course will become highlighted. The user may then select an add/remove course button 122. This function will place the course selected into the courses selected area 120 for the specific program. The selected course is now registered as a part of the program.

The add/remove this course button 122 serves at least two purposes. After selecting the desired course from within the available course listing area 118, selecting the add/remove button 122 will add the course to the courses selected area 120 if it has not already been registered for the program. If the course has previously been registered, and is already listed in the courses selected area 120, the add/remove button 122 will remove it from the courses selected area 120, and will unregister it for the program. This is a helpful tool if the institution has curriculum changes, or if the user has simply made an error in selecting the course.

As courses are added to the courses selected area 120, the length of selected courses field 114 at the top of the screen will increase incrementally based on the number of units in the course being added. When all appropriate courses have been selected for this program, the length of selected courses 114 value should equal the total program length field 116 value.

The user has now successfully added a new program to the database or list. To add another program, select the add a record button 85 of the record scroll bar 75. The record number will increase by one, and a blank screen will be available to add another program. This procedure may continue until all programs have been added to the system.

FIG. 6 shows the institutional student tracking system's school module with the admissions reps tab 126 selected. The admissions reps tab 126 of the school module 40 contains a database or list of all admissions representatives employed by the institution. When creating a new student record, the user will have the opportunity to select which admissions representative recruited the specific student. This can be an invaluable tool to ensure employee performance. The ISTS will generate admissions rep performance reports indicating not only who recruited whom, but also how long it took an employee to finalize the matter.

A user can add admissions representative records and may create an admissions rep database or list. The user may enter the name, address, and phone number(s) of an admissions representative into the fields provided in the student name area 128, student address area 130 and student telephone area 132. The user may use the [tab] or [enter] keys of the users keyboard or other device to navigate through the fields in the areas 128, 130 and 132.

### Type of Employment

A type of employment area 134 may also be provided having an institution check box 136 and an outside agency check box 138. Admissions representatives may either be employed directly by the institution, or may be subcontracted through an outside agency. The user would select the appropriate check box 136 or 138 indicating the admissions representative's correct place of employment. A field will appear (not shown in FIG. 6) under the outside agency check box 138 for the name of the agency if this option is selected.

The user has now successfully added a new admissions representative to the database or list. The user may add another representative by selecting the add a record button 85 of the record scroll bar 78. The record number will increase by one, and a blank screen will be available to add another admissions rep. The user would continue until all admissions employees have been added to the system.

FIG. 7 shows one form of the institutional student tracking system's school module with the lead sources tab 140 selected. The lead sources tab 140 of the school module 40 contains a database or list of common methods of advertising. When creating a new student record, a user will have the opportunity to select which advertising method was most instrumental in the student's decision to contact the school. The ISTS will generate lead source reports indicating which methods of advertising are and are not successful. This feature can help an institution decide whether or not to continue wasting revenue on unprofitable advertising.

In one embodiment, the ISTS has been pre-programmed with seventeen of the most popular methods of advertising used by institutions. A user can view this list of lead sources alphabetically by clicking on the sort button 142 provided on the lead sources tab screen 140. FIG. 8 shows examples of the pre-programmed lead sources that can be entered in the system. After the user views this list, the user may select file from the menu bar 32, then select close to return to the lead sources tab screen 140.

A user may add as many additional lead sources as wished to customize the system to meet the user's specific needs. A user may add sources by selecting the add record button 146 in the lead sources name area 144 and scroll bar 148 and entering the name of the advertising method in the field 150 marked lead source name.

FIG. 9 shows one form of the institutional student tracking system's school module with the employer's tab 152 selected. The employer's tab 152 of the school module 40 contains a database or list of all businesses with which an institution places its graduate students. Each student record in the ISTS has a tab 152 wherein a user can record which employer has hired a graduate. The functions of tab 152 in the student record are to document placement, prepare annual report information, and in some cases will assist a user in future default management.

Adding employer records to the ISTS is similar to adding subjects or programs in their respective screens. When a user adds a first employer to the system, the record scroll bar 156 will indicate record #1, and the fields in employers information area 154 on the screen will be blank. The user may enter the appropriate demographic information for the employer in the respective fields shown in the employer's information area 154. The comments field can be used as a notepad to enter relevant facts or preferences about this employer. A user may enter an employer record for any business that is a prospective employer of its students.

The user has now successfully added an employer to the database or list. To add another employer, the user may select the add a record button 158 of the record scroll bar 156. The record number will increase by one, and a blank screen will be available to add another employer. The user would continue until all employers have been added to the system. To edit an existing record, the user may scroll through the records using the record scroll bar 156 until the record to edit is displayed.

FIG. 10 shows the institutional student tracking system's school module with the holiday's tab 160 selected. The holiday's tab 160 of the school module 40 has three basic components. The holiday's tab 160 of the school module 40 contains a database or list of all dates on which the school is closed. These holidays are relevant regarding the accurate calculation of student's projected program completion dates. The ISTS already assumes a five-day school week, therefore, it is not necessary to register weekends as holidays.

### The Calendar

The calendar area 162 serves as an add/remove feature that will add a particular date to the holiday list if it has not already been selected, or it will remove a particular date from the holiday list if it has previously been selected as a holiday.

To add a date to the scheduled holiday area listing 166, a user selects the appropriate month and year from the available pick lists, and then selects the desired date. The date will be added to the selected holidays area listing 166. If the date is already selected as a holiday, this function will remove it from being a holiday.

### Selected Holidays

Dates selected as holidays will appear in the selected holidays area list 166. When the number of dates selected exceeds the space provided in the list box, a vertical scroll bar (not shown in FIG. 10) will appear along the right (or left) side of the list box allowing a user to easily scroll through the holiday listing. Occasionally, a user can remove old holidays to simplify the list, but be sure all students currently enrolled were enrolled after the old holiday. A user may register several years of holidays since some part-time students may be enrolled over that period of time. For example, if a student is projected to graduate in Spring 2003, and the holiday list ends at Dec. 31, 2002, the completion date will not reflect holidays in early 2003.

### Recalculating Projected Completion Dates

A recalculate projected completion dates button 164 may also be provided as shown in FIG. 10. Occasionally, it may be necessary to add dates to the holiday listing after students are already enrolled, and their projected completion dates have been established. To achieve this objective, a user may select button 164.

If a user has determined that a particular holiday is missing from the selected holiday listing, the user may add the holiday in the manner described above. Adding a holiday, however, will not automatically adjust student records regarding satisfactory attendance achievement and projected completion dates

Although automatically recalculating student attendance records each time a holiday is added can be viewed as a more efficient process, this recalculation can take from several seconds to several minutes depending on how many student records are in the ISTS. The ISTS has been designed to allow for multiple additions of holidays followed by a single recalculation of student records.

This optional feature provides a special benefit to institutions located in climates where snow days may be commonplace. In these areas, it's impossible to forecast that the school will be closed for some unplanned, unexpected reason. The ISTS will ease the burden of manually adjusting student records to account for these types of unexpected school closures. Once a user has completed the setup of the school module 40 the user is ready to begin creating student records in the system. The school module 40 is where the critical, daily student records are maintained. On a continual basis, data in the student module 40 is constantly changing. New students are added. Attendance, grade, and accounts receivable information are recorded, and documents and appointments are being monitored. All of this information is readily available in the student module 40.

### Student Module

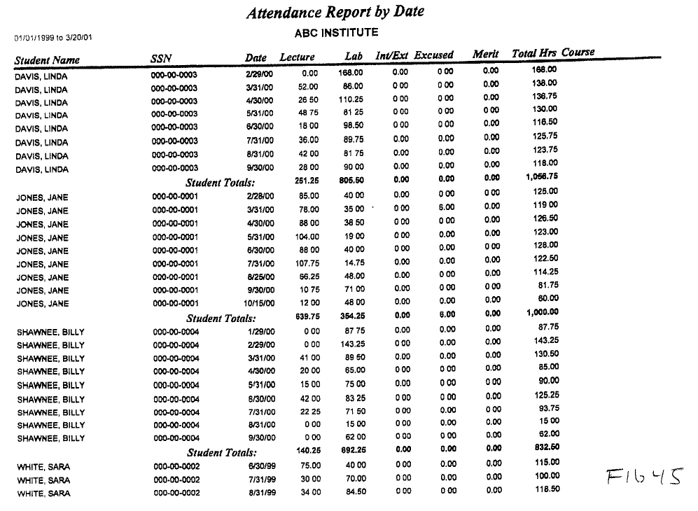

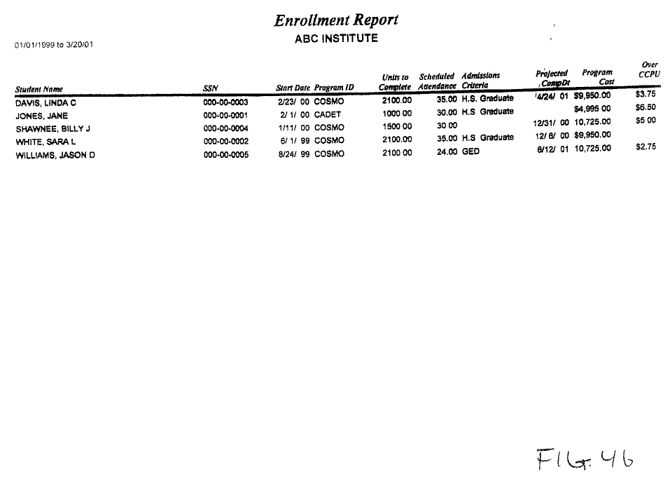

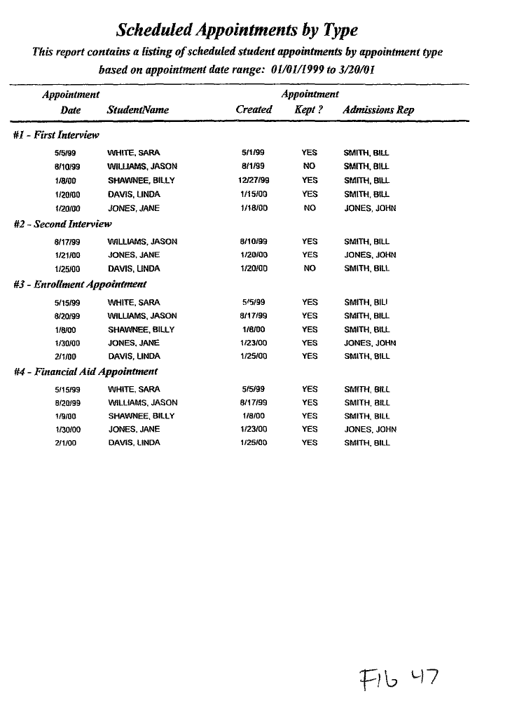

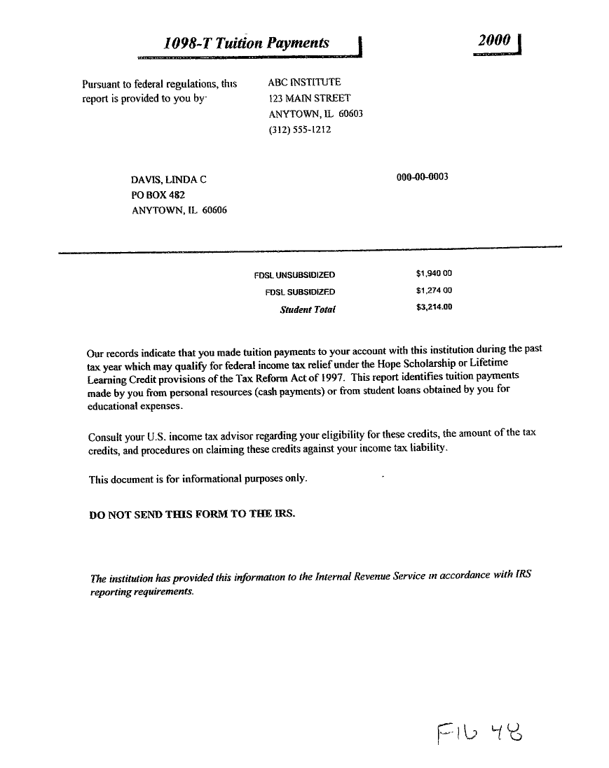

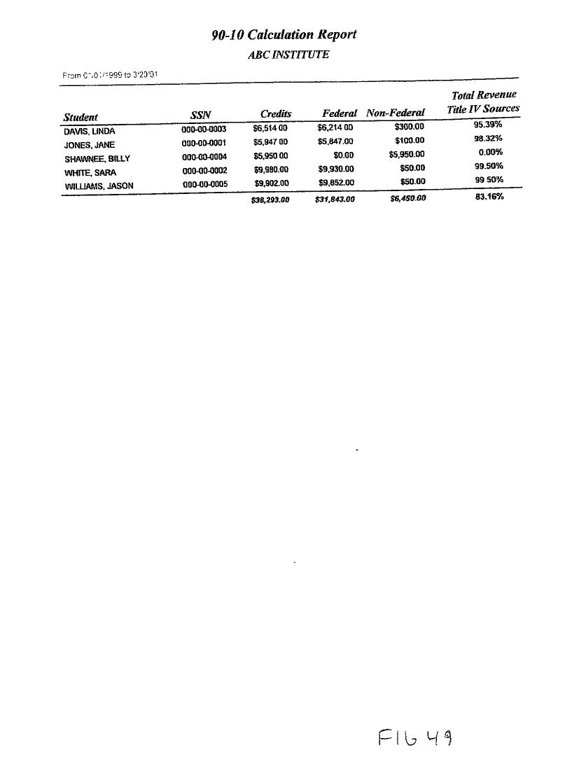

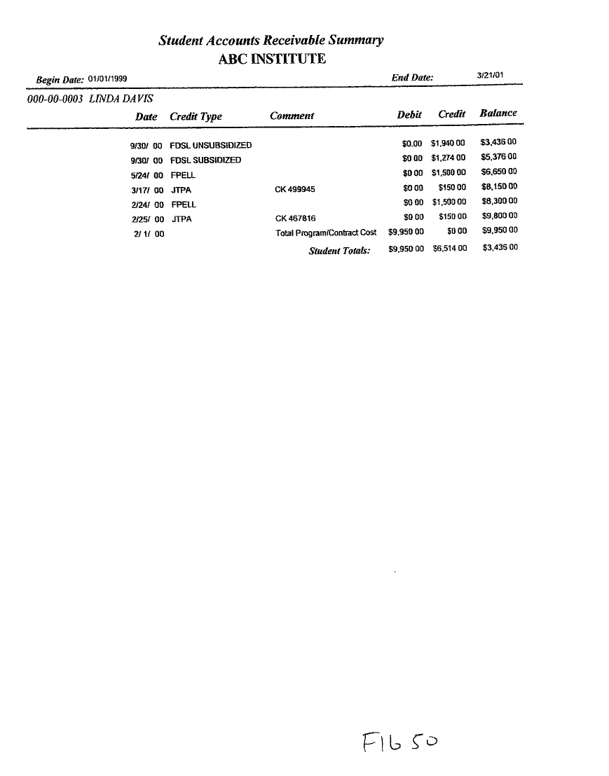

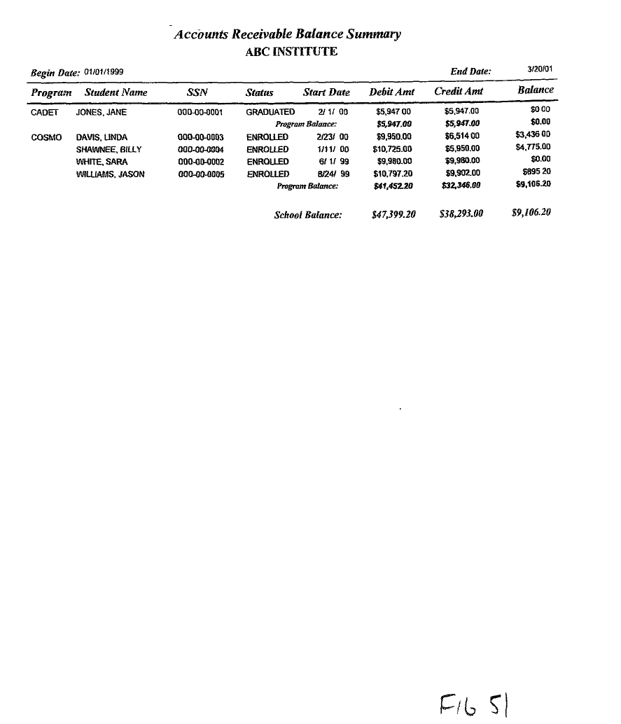

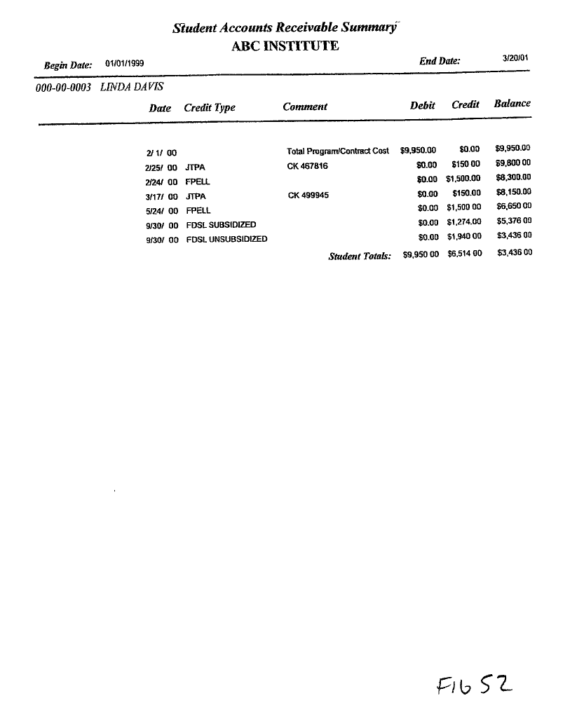

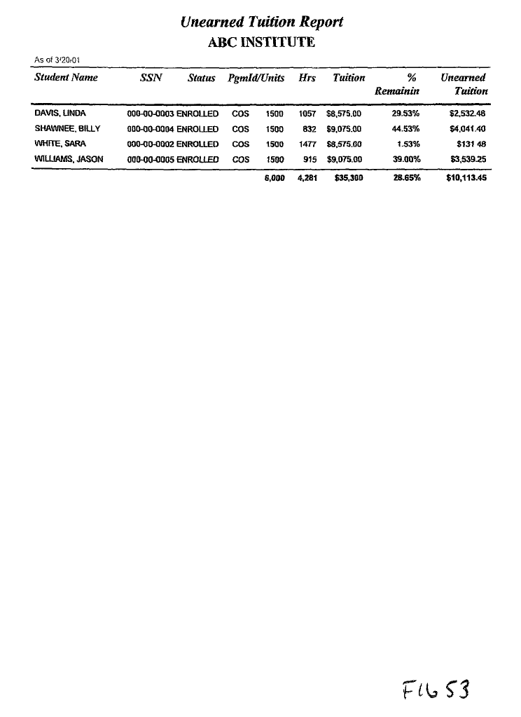

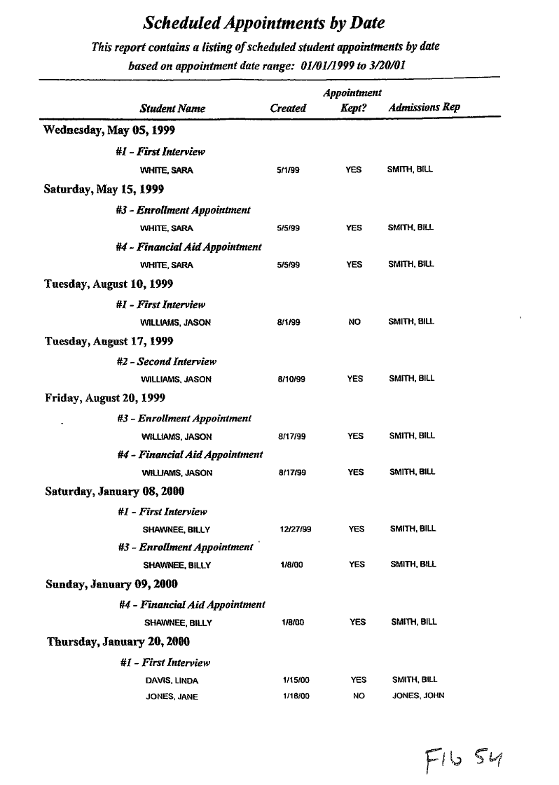

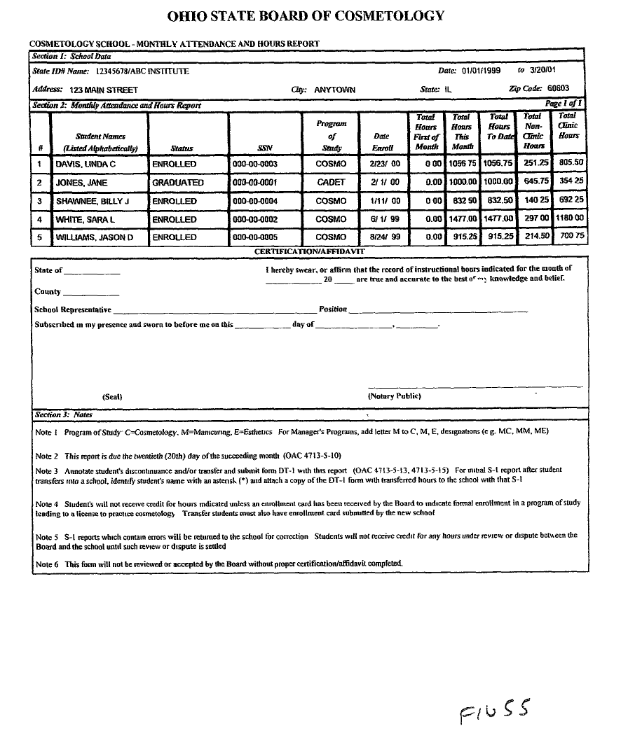

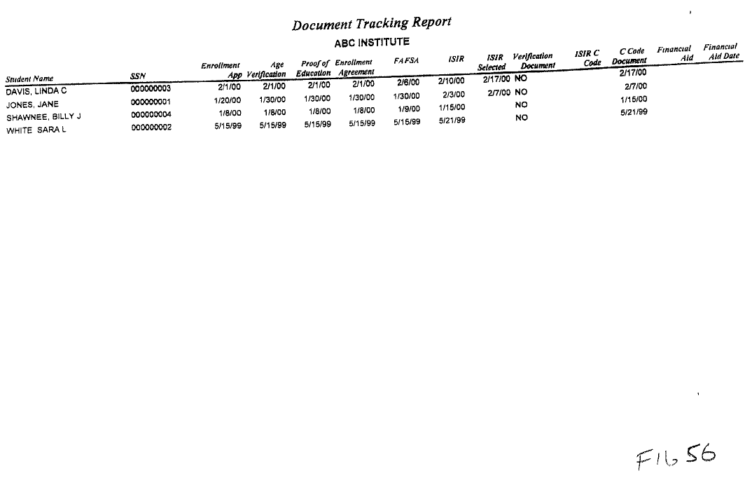

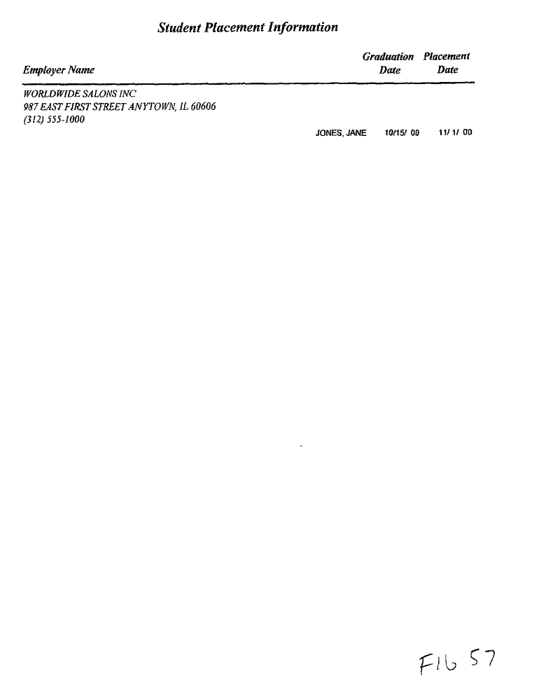

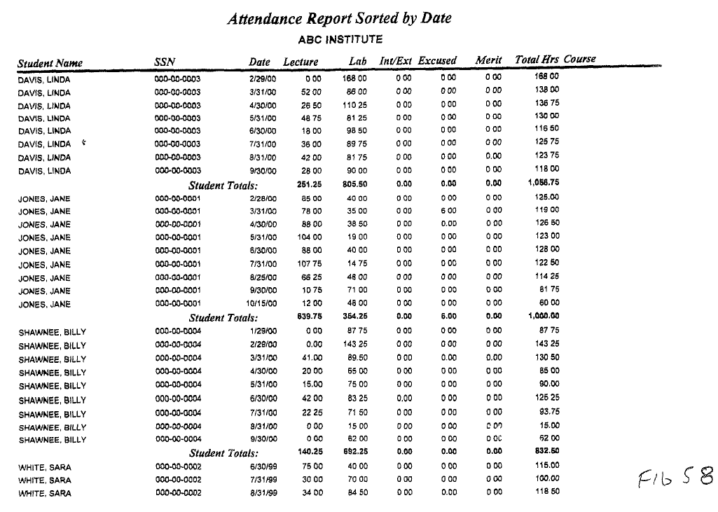

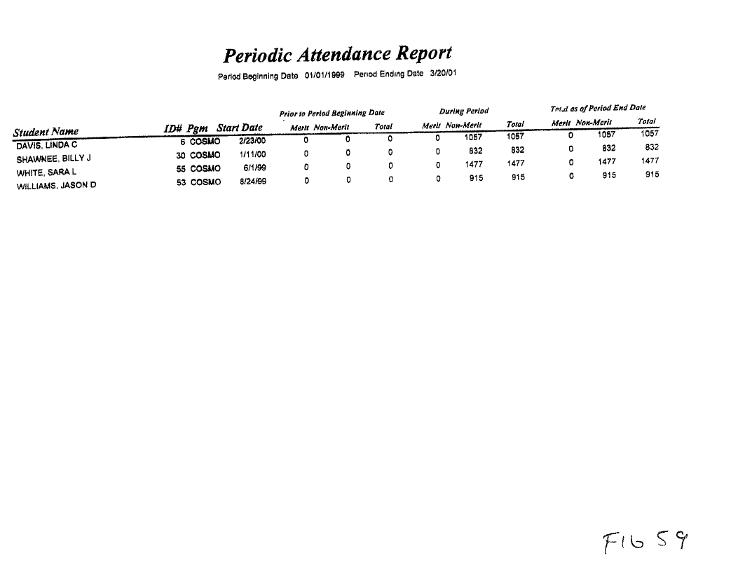

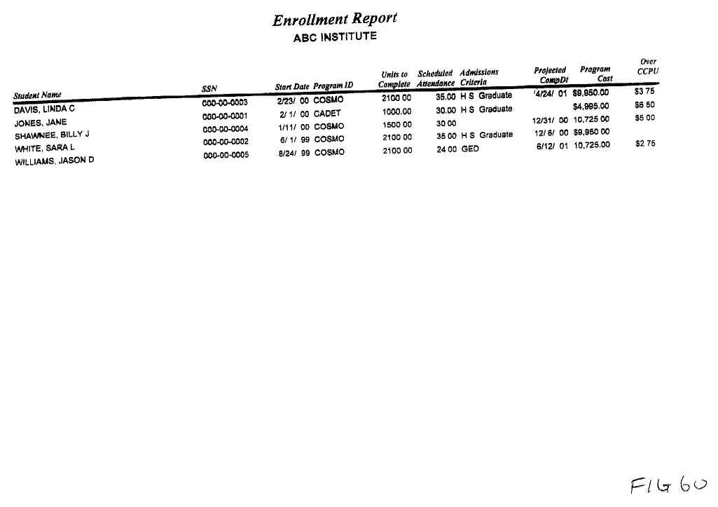

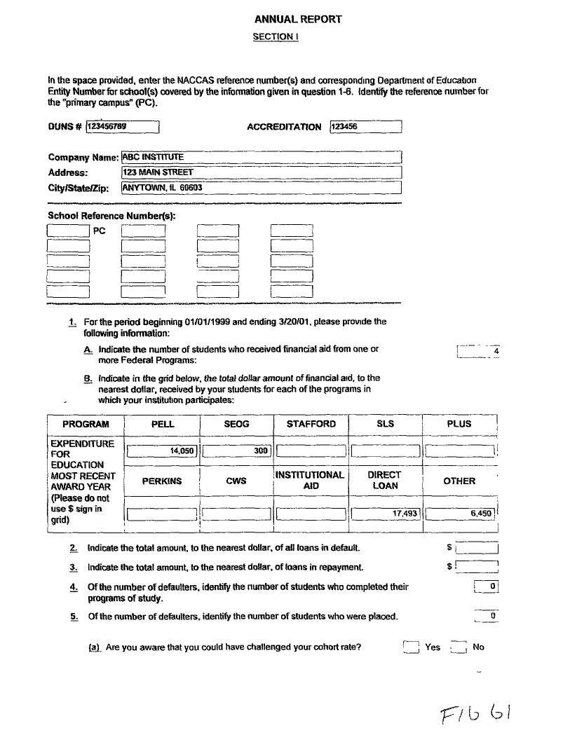

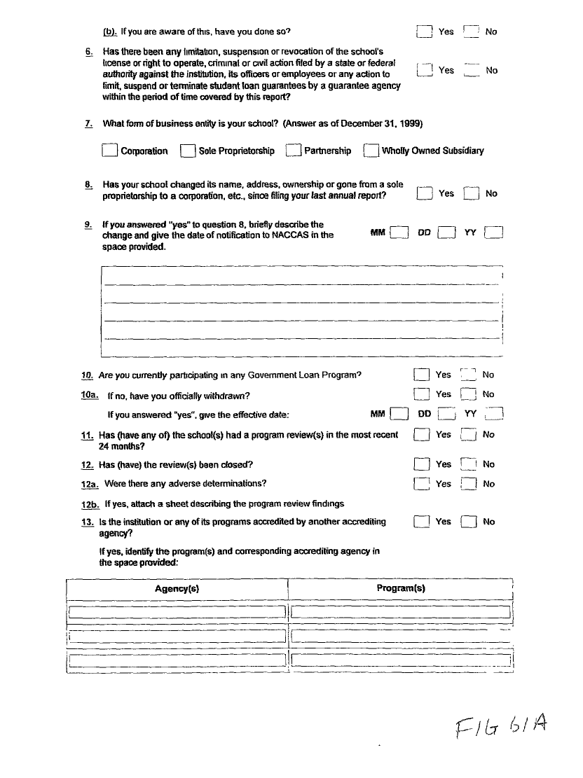

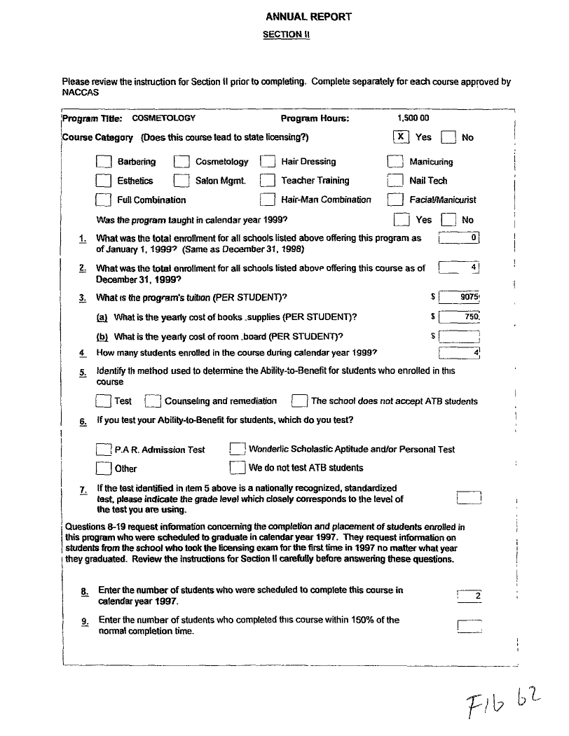

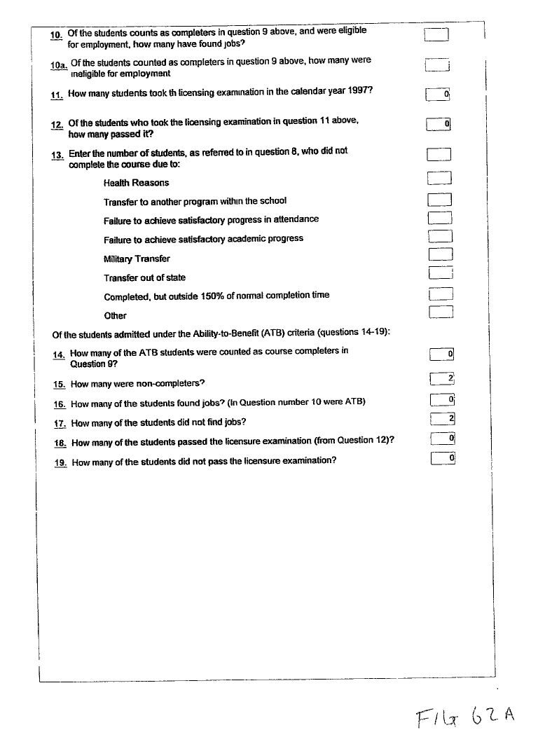

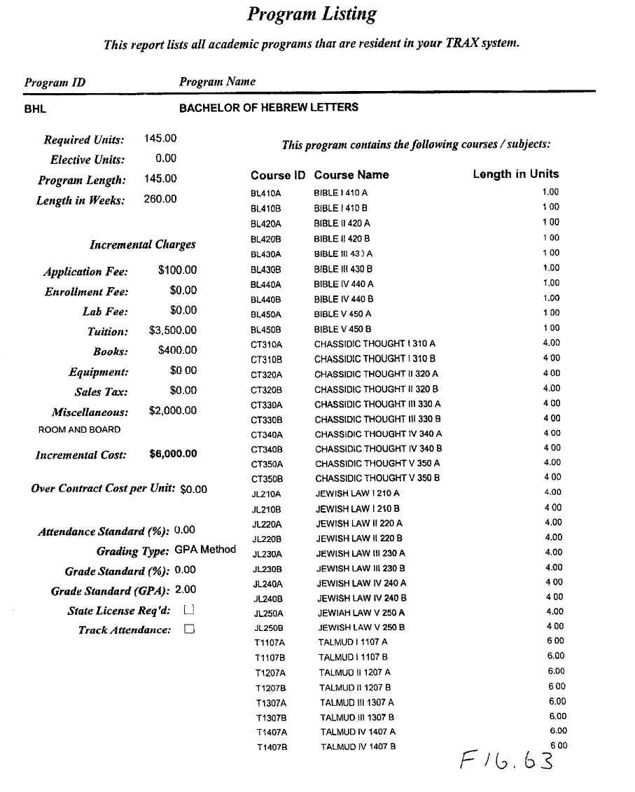

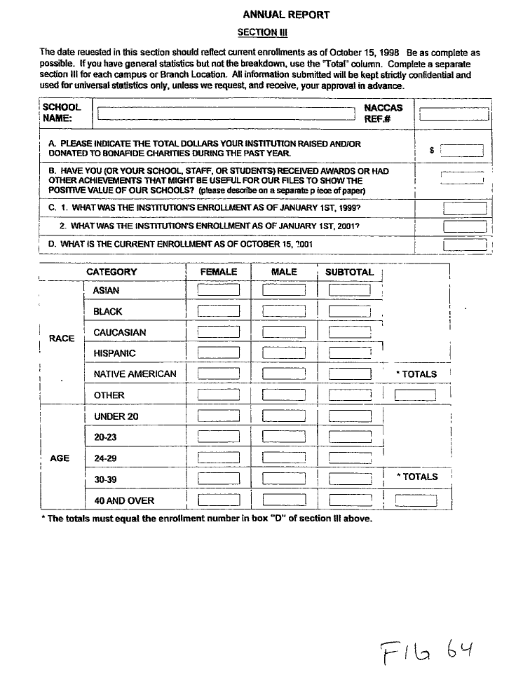

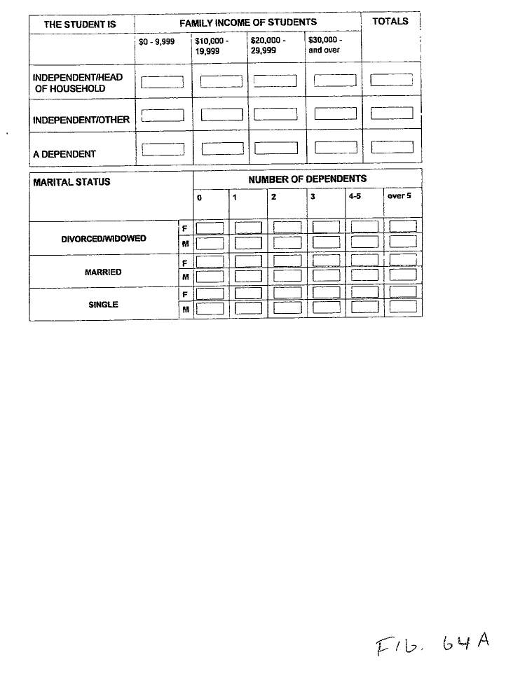

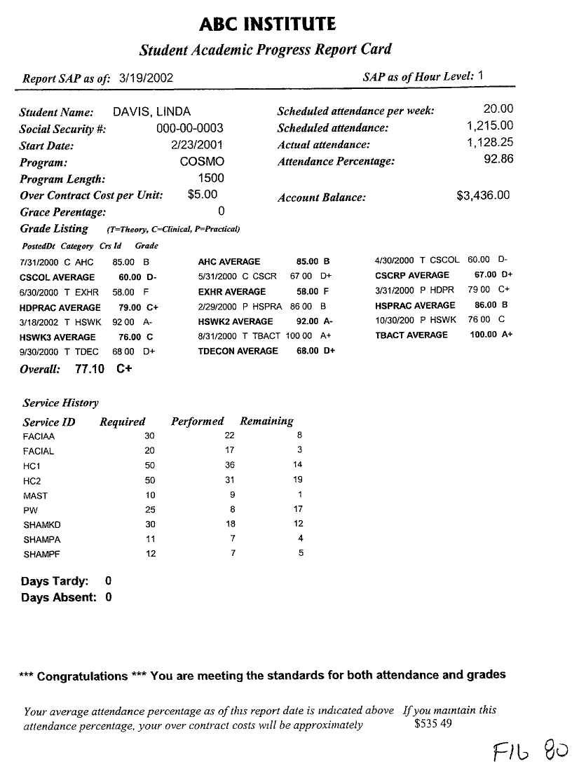

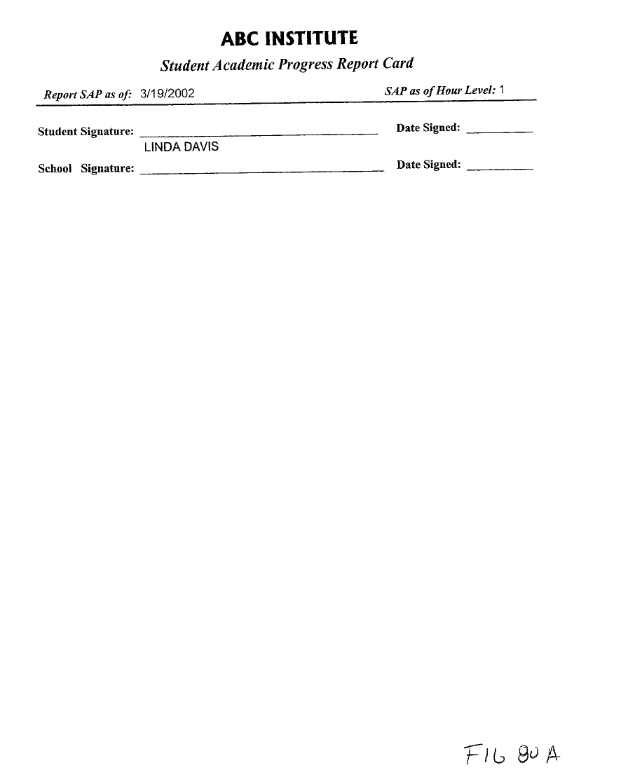

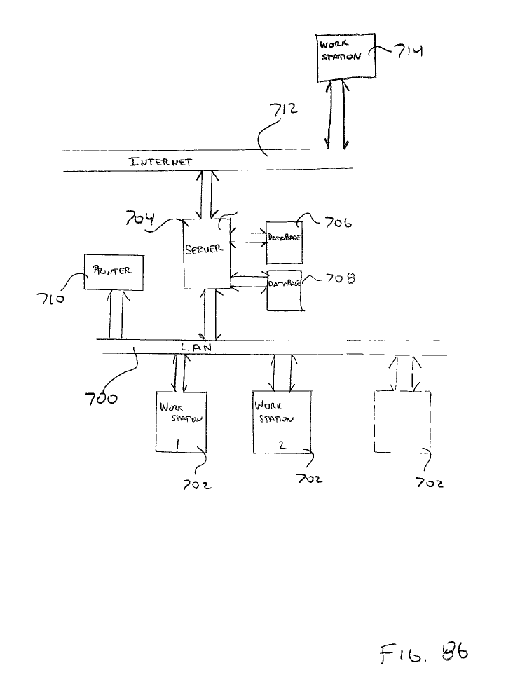

FIG. 11 shows one form of the institutional student tracking system's select student screen of the student module. In one form, the select student screen 170 is designed with three areas to make student record access or creation a user friendly process. In one embodiment, a variety of different reports may be generated from the student module 186 or by other modules of the ISTS such as for example report shown in FIGS. 39-64A, 77 and 78. FIGS. 83 and 85 shows a schematic view of a flow chart for one embodiment of the student module 186.

### Selecting an Existing Student Record

The select student screen has a select active student area 172 and a select inactive student area 174 as shown in FIG. 11. Selecting an existing student record in the student module 186 is based on whether or not the student is considered active or inactive. Student records have been divided in this manner to eliminate the burden of having to scroll through large amounts of data to find currently attending students. Each selection type offers the option of selecting the record by social security number or by name. To view records available in the pick list, a user would select one of the pull down arrows 178, 180, 182 or 184. A list of student records will appear. A user would then scroll through the list, and click on the student record required to view.

In one form, active records are defined as those students whose enrollment status is one of the following: enrolled, or less than half time and inactive records are defined as those students whose enrollment status is one of the following: prospect, leave of absence, withdrawn, terminated, graduated or did not start.

### Adding New Student Records

The select student screen 170 also has an add a new student area 176. The add a new student area 176 as shown in FIG. 11, will create a new student record in the database. A user may enter the social security number and first and last name of the student in the fields provided in the area 176. Upon completing these three fields, the user may press [enter] on the users keyboard or other device. An add record button will appear. The user would select the add record button to add the student record.

There may be occasions when a prospective student is unwilling to provide his/her social security number during an initial contact. In one form, the system accounts for this occurrence by assigning a temporary social security number (SSN) to a student record. To create a prospective student record without a valid SSN, the user may enter 999-99-9999 in the SSN field. The ISTS will automatically assign a temporary SSN value to create the record. Temporary SSNs will begin with the value 000-00-0001 for the first temporary SSN, followed by 000-00-0002 for the second, etc. When the user has the actual SSN for the student, the user can easily change the temporary value to the actual value using the utilities module.

FIG. 12 shows one form of the institutional student tracking system's student module screen with the general tab selected. This screen 188 will be blank when adding a new student record to the ISTS. The student module 186 may be designed in the same manner as the school module 40. The general tab screen 188 of the student module 186 displays basic demographic information about the student and includes a student name and information area 190, a student address and phone number area 192, an emergency information area 198 and a name of previous college area 196 as shown in FIG. 12. Also, the general tab screen 188 provides a classification area 194 to track student classification, i.e., new, returning or transfer, emergency contact information, and current status. Further, a student status area 200 may be provided. When a user creates a new student record, in one form, the status will default to prospect. Upon enrollment, the status will update to enrolled. When changing the status manually, as with drops, graduates or leaves of absence, the system date will default as the status change date. The user, however, may adjust this value. This status field is what determines whether the student is active or inactive, when later selecting the record from the select student screen 170.

FIG. 13 shows the institutional student tracking system's student module with the prospect tab screen 202 selected. The prospect tab screen 202, displays all information relative to the student's status as a prospective student. In one application, information from this screen is gathered for three independent purposes; marketing analysis and performance reports, daily schedule planner, and annual reporting. Screen 202 contains a contact information area 204, comments area 206, interview information area 208, prospect status information area 203, prospect personal information area 214, acceptance letter area 210 and close date area 212. Comments area 206 can be used to store any text messages a user wants to retain in the student's file for future reference. Although not all fields in the different areas are required to contain an entry, the completeness of the database or list is directly related to the accuracy and value of the reports ISTS can provide to an institution.

The contact date area 204, combined with the close date area 212 will provide an analysis of how long it took to finalize matters with the prospective student. Using information such as the admissions representative and lead source that brought this student to the school will enable helpful employee and advertising performance report generation.

Based on entries in the prospect tab screen 202 and areas, admissions representative performance reports will analyze how many prospective students were enrolled, not interested, or rejected on an admissions rep specific basis. These reports can be invaluable during reviews of the employees' success.

By using information contained in the interview appointment area 208 a user will know exactly what's on it's to do list for tomorrow with ISTS daily schedule planner. The information will assist with setting up appointments for interviews, enrollments, or financial aid. For example, a user can post the date on which an appointment was created and the date of the appointment and print out a schedule for any date range desired.

FIG. 14 shows one form of the institutional student tracking system's student module with the tracking tab selected. The tracking tab screen 216 provides a database or list to ensure that critical documents do not go uncollected. Screen 26 provides for a user to enter the date that each document was received, and print out lists of missing documents. As shown in FIG. 14, screen 216 may have a document name area 218 for documents such as enrollment application, age verification, proof of education, or any other document identified in area 218 or any other document that the institution uses, a date received area 220 provides the institution with a way to identify which documents were returned to the institution and on which date. A document name area 222 may also be provided for documents such as consumer information, registration letter and financial aid transcripts and a date sent area 224 is provided to track when the letters were sent. A date received area 226 may be provided to track when letters from area 222 were received. An incentive programs offerings area 228 may be provided with a date extended area 230 and a date redeemed area 232 as shown in FIG. 14. Student retention is an issue that affects all schools regardless of their curriculum. Some schools have found that incentives can be helpful in improving student retention. This area of the incentive area 228 can provide a record of any incentives extended to and redeemed by students at the school.

FIG. 15 shows one form of the institutional student tracking system's student module with the enrollment tab selected. The enrollment tab screen 234 of the student module 186 is where a prospect officially becomes a student. After the enrollment agreement is signed, the enrollment screen 234 will create the students active student record. The enrollment screen 234 is made up of three general areas, an enrollments process area 236, a creating accounts receivable record area 246 and a changing enrollment status area 252.

### The Enrollment Process

The process of creating an enrollment record for a student is accomplished in the enrollments process area 236. In this area, information is entered regarding the student's start date, program of study, and attendance schedule.

As shown in FIG. 15, the following enrollment facts for this student record are:

| | |
|---|---|
| Start Date | 02/15/2000 |
| | (Enter the student's start date) |
| Program of Study | MA |
| | (Select from list of program records created in |
| | School module) |
| Program Units | 1500 Clock Hours |
| | (System generated based on program record |
| | selected above) |
| Transfer Units | 0.00 |
| | (Indicate the number of clock hours transferred |
| | from prior training) |
| Enrollment Status | Full Time |
| | (Select Full Time [FT] or Part Time [PT] from |
| | list) |
| Units to Complete | 1500 Clock Hours |
| | (System generated using program length minus |
| | transfer units) |
| Scheduled Attendance | 30 |
| | (Enter the number of hours per week of scheduled |
| | attendance) |
| Proj. Completion Date | 02/05/2001 |
| | (System generated based on scheduled attendance |
| | per week) |
| Admissions Criteria | High School Graduate |
| | (Select from available choices in list) |

Once enrolled a user will be able to post attendance records, grades, and accounts receivable data, along with running various student based reports.

### Creating an Accounts Receivable Record

Creating an accounts receivable area 246 in FIG. 15 shows another area of the enrollment screen 234 and identifies the current costs for the program in which the student has enrolled. Upon selecting the specific program of study in which the student is enrolling, the ISTS will obtain the default cost information from that program record as stored in the school module 40. This cost information will be displayed on the enrollment screen 234.

Before actually creating the student's accounts receivable record, the user may confirm that the costs displayed are the actual costs this student is being charged. In some applications, modifications may be necessary for transfer students, or if the user has not updated the program record in the School module 40 to reflect a change in fees. The system will calculate the total program cost in area 246 as shown in FIG. 15. The over contract cost fee area 250 represents the per hour charge assessed for attendance beyond a projected completion date. In one form, this fee will never be automatically charged to a student. A debit entry will need to be made by the user.

After the user has confirmed that the cost information is accurate for this student, the user would select post programs fees to A/R button 248 to create an accounts receivable (A/R) record, and post the initial charge to the student's account.

### Changing Enrollment Status

Changing enrollment status area 252 is shown on FIG. 15. Using this area 252, a user can record an unlimited number of status changes for a student throughout his/her attendance at the school. Each time a student elects to modify his/her scheduled attendance commitment is treated as an independent period of time. For example, if a student begins his/her program at a 30 hours per week schedule. Six weeks into classes, he/she requests a change down to 15 hours per week. This schedule continues for four weeks. Then, a four-week leave of absence ensues. The student returns from the leave at a 20 hour per week schedule, but withdraws two weeks later. In one embodiment, the ISTS can record each of these attendance segments, and accurately determine the student's aggregate attendance commitment. As shown in FIG. 15, area 252 identifies and tracks that each attendance segment has a start date and an end date, and a scheduled attendance per week component is identified in area 236. This value on the enrollment screen 234 represents the student's scheduled attendance per week during the current attendance period, or segment.

When a user needs to change a student's schedule, the user may enter the end date of the current attendance segment in area 252, and select the change enrollment status button 238. The period of time for this segment is recorded along with the scheduled attendance per week value from above. After the user selects the change button 238, the user may now enter the new scheduled attendance per week value in the appropriate field in area 236. This now represents the status for the current (second) attendance segment.

For subsequent changes in status, the user would perform the same procedures. Enter the end date of the current segment and click the change status button 238. The user would then enter the new scheduled attendance per week value in the appropriate field in area 236 representing the schedule for the next segment.

The status start and status end fields in area 252 represent the start and end dates of each individual attendance segment. After first enrolling a student, the status start date will be equal to the actual start date in the program. The first attendance segment will begin on the program start date.

For example, the data shown in FIG. 15 represent a student who started on Feb. 15, 2000 at 30 hours per week. This is the current attendance segment because there is no end date specified. If the student elected to change status to 15 hours per week as of May 01, 2000, the user would enter Apr. 30, 2000 as the end date (the last day of attendance at a 30 hour per week schedule). The user would then select the change enrollment status button 238.

This segment from February 15 to April 30 will be displayed in the enrollment status area 236 of the screen 234 along with the 30-hour schedule and the total hours scheduled during this segment. The status start field will then automatically adjust to May 01, indicating the start date of the next attendance segment.

Also provided is list box 242, which will display all student schedule changes that a user has recorded for this student. In the event of an error in recording schedule changes, a user may make corrections using the review enrollment status history button 240.

### Editing Enrollment Status History

Another important and unique feature of the ISTS is its error correction capabilities. In one application, this feature is found in the area of enrollment status history correction. Throughout a student's enrollment, there may be a number of attendance schedule changes. And, from time to time, errors will be made. If a user should encounter a situation where a prior enrollment status change was made incorrectly, reviewing or modifying past changes is user friendly.

After selecting the review enrollment status history button 240, a password screen (not shown in the Figs.) will appear to allow a user to enter a review enrollment status history screen 252 shown in FIG. 16. This screen 252 will display all prior attendance schedule changes that were made on this student record. As shown in FIG. 16, in one example, screen 252 enrollment history area 253 indicates that this student had three prior schedule changes. The first segment for approximately 15 weeks was based on a 30 hour per week schedule. The next segment of almost 9 weeks was at a 20 hour per week schedule, and the last segment reflects a leave of absence wherein no attendance was scheduled. Using the enrollment status change feature in the ISTS will enable a user to accurately track attendance and satisfactory progress regardless of the number of different attendance schedules a student may have during his/her enrollment at the school. And, modifying prior changes is as easy as going to the erroneous field and correcting the value to what it should have been. After modifying any erroneous values, exit button 72 is selected to go back to the student's enrollment screen 234. A refresh button 244 is provided on screen 234. A user may select button 234 and this process will recalculate all prior attendance schedules and adjust the student record accordingly.

FIG. 17 shows the institutional student tracking systems student module with the attendance tab selected. The attendance tab screen 254 of the student module 186 gives the ability to enter attendance records, to view a complete history of the student's attendance, and to view cumulative totals of scheduled attendance, actual attendance, percentage achieved, and projected overage fees.

### Posting Attendance Records

For schools not equipped with electronic time clocks, manual posting of attendance. Users can elect to enter attendance into the ISTS on any interval desired, i.e., daily, weekly or monthly. Attendance tab screen 254 has an attendance area 262 that provides for course attendance information as shown in FIG. 17. To enter an attendance record, the user may enter the date and the number of hours attended in the appropriate category in are 262 based on whether the attendance was lecture, lab, etc. When the total hours value is accurate for this attendance record, the use may select a post attendance button 268. The record will be created and listed in the attendance history area 256. If a user wants to record attendance by subject/course, he/she selects the desired course from the pick list in are 262 before selecting the post button 268. If posting attendance for a week or month at a time, the user may use the last date for that period as the posting date

Error corrections in the area of attendance are also easy to perform. If an attendance record was erroneously entered, the user may change or remove the record by selecting the entry in question from within the history area listing 256 and selecting the appropriate change button 258 or remove button 260.

FIG. 18 shows one form of the institutional student tracking system's student module with the grades tab selected. The grades tab screen 270 of the student module 186 gives the user the ability to enter grades achieved and to view a complete history of the student's academic achievements with a cumulative grade average to date.

### Posting Student Grades

Posting student grades is done in a similar fashion to the attendance posting procedures. Each grade a student achieves in a particular subject/course should be entered into the ISTS. This information may be retrieved and averaged for satisfactory progress purposes.

To post a grade for a student, the user may enter the date in the date field 272 of the exam or assignment, select the course from student courses list box 274, enter the grade achieved in grade field 274, and select post this grade button 276. The record will be created and listed in grade history area 278. If the user records grades based on a special category, i.e., theory, practical, or clinic/lab, the user may select one of the desired category check boxes 280 before posting. Each time an additional grade is posted to the student record, the system will automatically recalculate the student's cumulative grade average to date. This represents the average of all student grades posted in the system to date. However, in one embodiment, when processing satisfactory progress evaluations or report cards for a prior point in time, only those grades will be retrieved and averaged to provide a snapshot of the students progress as of that particular date.

Error corrections in the area of grade posting are also easy to perform. If a grade was erroneously entered, the user may change or remove the record by selecting the entry in question from within the history listing area 278 and selecting the appropriate change button 282 or remove button 284.

FIG. 19 shows one form of the institutional student tracking system's student module with the accounts receivable tab selected. The accounts receivable tab screen 286 of the student module 186 has a standard debit, credit, balance ledger system to track student receivables. Charges and receipts can be posted in this screen, ledgers can be printed, and up to date unearned tuition and receivables balances are readily available.

A student's accounts receivable account is actually created when the student is enrolled. Credits represent payments applied to the student's account from personal or financial aid resources. Debits represent charges to the student account. At the enrollment stage, an initial debit entry will be automatically posted for the total amount charged to the student. After the receivables account is created, future postings of debits and credits are done on the accounts receivable tab screen 286. Each time a credit or additional debit entry is posted, the record will be displayed in the transaction history list area 288 and the balance is updated.

### Posting Credit Records

A user can post a credit entry to a student's account by entering the date in the transaction date field 290, enter the credit amount in field 292, select the credit type from pick list 294, and select post transaction button 296. The account will instantly be updated to reflect the payment. Transaction history area 288 will reflect the student's transaction history information. The comment area 298 may be used for any additional, unique text the user wants to be associated with this entry. The print student ledger button 306 will generate a report of the students A/R history.

In one form, the ISTS has a 90-10 Rule calculation feature. This feature allows the user to print a report of revenue broken down into Title IV funds revenue and non-Title IV funds revenue. As with any software system, reliable reports are only achieved through reliable data. Failure to select a credit type when posting receipts will result in inaccurate 90-10 rule calculations.

### Posting Debit Records

A user may post debit entries, reflecting additional charges to a student's account, by selecting the debit field in the type area 300. This will adjust screen 286 to accept debit entries rather than credit entries. A user may post a debit entry to a student's account, by entering the transaction date, entering the debit amount, and selecting the post transaction button. The account will instantly be updated to reflect this additional charge. The user may se the comment field provided for any additional, unique text the user wants to be associated with this entry.

The unearned tuition balance area 302 is an amount representing the value of the training still remaining to be provided to the student. It is determined using the student's contracted charges and his/her hours in the program remaining to be completed. The amount displayed here is a real time, up to date figure. The A/R balance area 304 value represents the current balance owed to the school by the student. It is determined using all debits and credits posted into the system to date.

The placement screen of the student module continues tracking students even after they've graduated. Keep information regarding where they are employed, and for how long, to document placement efforts and responsibilities.

### Tracking Graduate Placement

FIG. 20 shows one form of the institutional student tracking system's student module with the placement tab 308 selected. The benefits of the ISTS do not end when the student leaves school. The placement features of the system not only continue to track alumni, but also document an institutions placement efforts. Upon a successful placement, the user may select the employer from the pick list 310. The user may then enter the employment date in field 312 and the system will calculate a projected confirmation date in date area 314 thirteen weeks into the students employment. Then, the system can generate letters of confirmation to these employers at the 13 week threshold date. When return confirmation is received, a successful placement has been documented and the confirmation date area 316 may be updated. In addition to making placement documentation a less burdensome task, this information may be used by the ISTS to compile annual report information required by most nationally recognized accrediting agencies. Further, screen 308 may contain, as shown in FIG. 20, a student ineligible for placement check box 318, an employer address and information area 320, a state license information area 322 and a graduation date area 324.

### THE SAP MODULE

### Satisfactory Academic Progress

FIG. 21 shows the institutional student tracking system's satisfactory academic progress module 326. FIG. 83 shows a schematic view of a flow chart for one embodiment of the SAP module 326. The ISTS administrative software system provides for procedures to report on a student's academic progress (SAP). Satisfactory academic progress standards are very vague, and it would be difficult to find two schools that evaluate progress on exactly the same standards, at exactly the same points throughout a program of study. What is consistent about SAP standards is that all schools have them, and all schools evaluate a student's progress at established checkpoints throughout a program. Satisfactory academic progress is generally measured on two levels, qualitative progress and quantitative progress.

### Qualitative Progress

A student's qualitative progress represents the ability or success that a student has achieved in the program at the time of the SAP evaluation. This measurement is often referred to as a grade average. A school's qualitative progress standards are usually measured as a percentage or grade point average (GPA), i.e., 75% or 2.0 GPA. Students must meet this minimum standard at each SAP evaluation or face probation, loss of federal aid, or even termination depending on the school's written policies. As the user records grades in the student record of ISTS, these grades are retrieved and averaged to determine whether or not a student has met grade requirements at a particular evaluation point. The minimum grade average a student must maintain is recorded in the program record of the school module 40. All students enrolled in that program are held to that standard. The SAP module 326 produces institutional summary reports and individual student report cards at whatever checkpoint or interval the user wants.

### Quantitative Progress

A student's quantitative progress represents the student's level of completion of the program based on attendance time. This measurement is often referred to as an attendance average. A school's quantitative progress standards are usually measured as a percentage of scheduled hours that a student must physically attend, i.e., 67%. Students must meet this minimum percentage standard at each SAP evaluation or face probation, loss of federal aid, or even termination depending on the school's written policies. As the user records attendance in the student record of ISTS, the attended hours are summed and calculated as a percentage of the total scheduled time that a student has committed to when he/she enrolled. For example, if a student has been enrolled for 10 weeks on a 30 hour per week schedule, and the attendance standard is 67%, the student must have physically completed at least 200 hours to be considered as meeting attendance standards [200/300=0.67]. The minimum attendance average a student must maintain is also recorded in the program record of the school module 40. All students enrolled in that program are held to that standard. The SAP module 326 produces institutional summary reports and individual student report cards at whatever checkpoint or interval the user wants.

Most schools have vast differences in SAP procedures. One of these procedures is how often to evaluate SAP. Whether SAP is evaluated on a monthly basis, quarterly basis, or based on a specific number of hours scheduled, the ISTS can accommodate the user.

To run satisfactory academic progress reports, the user would access the SAP module 326 as shown in FIG. 21. On the SAP module screen 326, in one form, the user has the ability to enter two values that will determine how the SAP report will be filtered. Only students who meet the values entered will be selected for SAP evaluations. The user may filter the SAP reports by date, and by interval.

### Date Filter

A user may enter a cut off date in date field 328 if the user wants to evaluate students' SAP as of a prior calendar date. This feature is beneficial for schools that evaluate SAP on calendar periods of time. If the user evaluates SAP on a monthly basis for example, the user could run an evaluation report as of the end of January 2001 by entering Jan. 31, 2001 as the cut off date. This will cause the system to ignore any attendance or grade entries after that date, and only report on the students' progress through Jan. 31, 2001. In one form, since evaluations are cumulative in nature, there is no need for a begin date. All progress will be measured from start date through cut off date.

### Interval Filter

An interval value field 330 is provided in one form as shown in FIG. 21. The interval value represents the total number of hours of scheduled attendance for this particular evaluation. This feature is beneficial for schools that evaluate SAP based on a number of hours as opposed to a calendar period of time. For example, entering an interval value of 300, will only evaluate students whose scheduled attendance is at least 300 hours. This will cause the system to filter out any students who have not yet reached this evaluation checkpoint. The user may also combine cut off dates and intervals, which will result in evaluations of only those students who have reached the specified interval by the specified cut off date. If the user does not wish to use the cut off date option and wants to run SAP evaluations to date, then the user would enter the current date in the cut off date field 328.

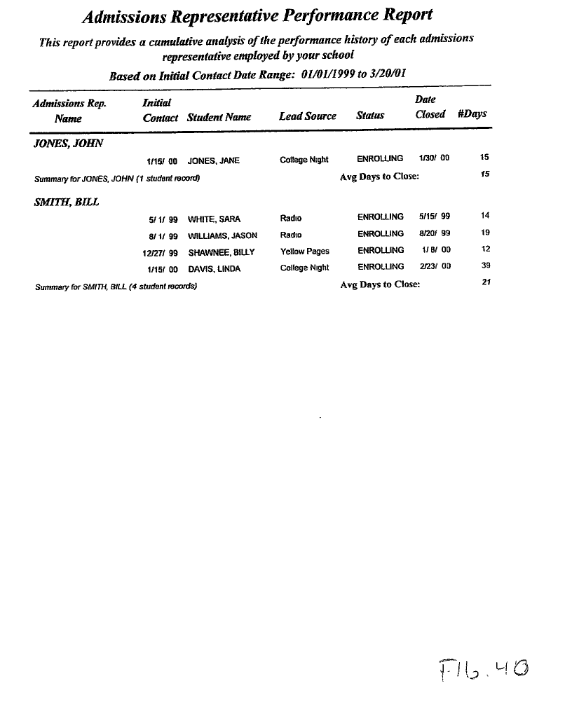

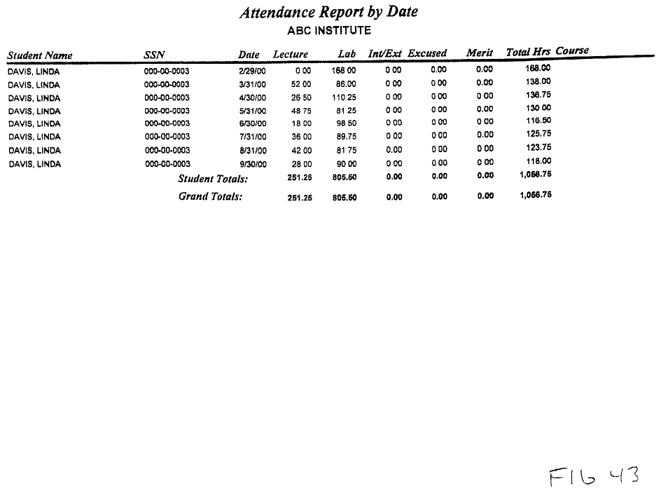

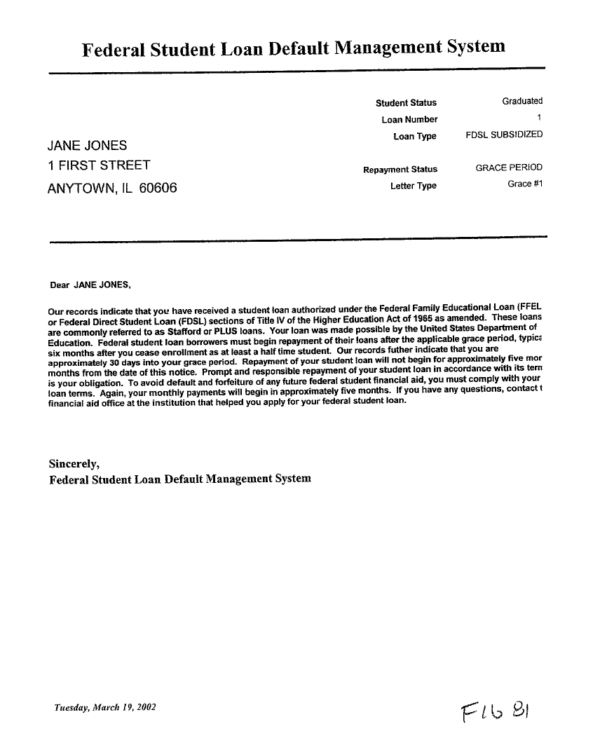

The ISTS will provide different types of SAP reports. For the school's use, the summary report (see FIG. 32) will provide a list of all students meeting the specified date and interval criteria and each student's status regarding compliance with SAP standards. For the student's use, detailed reports (see FIGS. 37, 79, 80, 80A) provides him/her with a report card of academic and attendance progress as of the specified date and interval criteria. A signature line may be provided on the report card should the user elect to retain a copy of the student's signed SAP report in its files.

To produce the SAP reports, a user would select the summary report button 332 or the detail report button 334. The selected report will be shown in preview mode on the screen, the user may then click access the menu bar 32 and select file and then print to produce a paper copy.

### THE REPORTS MODULE

FIG. 22 shows the institutional student tracking system's reports module 336. FIG. 83 shows a schematic view of a flow chart for one embodiment of the reports module 336. Some of the report functionality of the ISTS is obtained from the reports module 336. However, other reports are produced elsewhere in the system. Satisfactory academic progress reports are generated from the SAP module 326. Other administrative reports may be generated from the reports module 336. The reports module 336 provides reports based on total database content, as well as allowing the user to filter many reports either by specified date range, selected student, or both. As shown in FIG. 22, report types are separated into several categories for the user's convenience. For example, as shown in FIG. 22, module 336 may include a global report area with list 338, a marketing report are a with list 340, a daily schedule report area with list 342, a financial report area with list 344, a state specific report area with list 346, a general report area with list 348, an attendance/enrollment report area with list 350 and an accrediting agency report area with list 352.

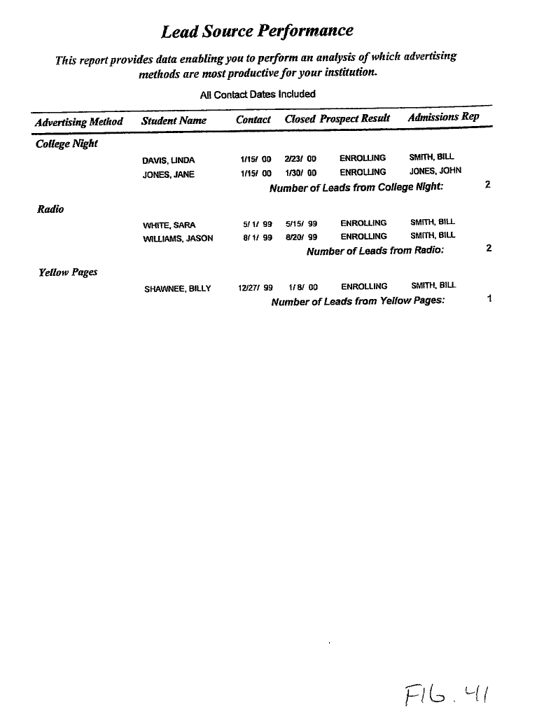

Each of the eight report categories has relevant reports available for convenience and business management. The ISTS may also contain additional report capabilities. See Example Reports FIGS. 32-64A and 77-82.

Most reports produced by the system are date specific, and will require a date range to be entered. Since global reports are printed copies of the data the users have entered in the School module 40 and contain course, program, holiday listings, etc., date ranges are not required. A user would select the desired global report from the global report area 338 and print the document.

In one embodiment, the ISTS report functionality utilizes a print preview approach to report generation. After selecting the desired report type, the report will appear on screen in preview mode. The user may then select the report to print if the report is what the user wants.

### Filtering Reports

Any report that excludes some of the data in the system is referred to as a filtered report. The user may filter a report based on a specific date range, or by specific student record. An attendance report for the month of January is an example of a filtered report since attendance achieved before and after January is excluded from the report.

### Date Range Filters

The user can filter a report for any date range from a single day, to several years. To filter a report by date range, the user may enter the begin date and end date of the desired period in date fields 354 and 356 respectively. Although, in one embodiment, the date fields may display a standard six-digit date, the system may use a year 2000 compliant eight digit date value. In this embodiment, date range values may be entered in the eight-digit format MM/DD/YYYY. For example, Jan. 31, 2001 may be entered as 01/31/2001.

There may be occasion for the user to require a report that includes cumulative data through a specific end date, i.e., no specific begin date. An unearned tuition report or accounts receivable balance report requested by the auditor as of the end of the fiscal year is an example of this type of report. To achieve this result, the user may enter a begin date early enough to include all transactions. There is no limit on how early a report can begin. Entering a begin date of Jan. 01, 1990, or even Jan. 01, 1900, would include all data through the specified end date in a cumulative report.

### Student Record Filters

Filtering a report to include only a single student is similar to the date filters discussed above. If the user wants to generate a report for a single student, the user would select the desired student from the student area and pick list 358, then select the report type, and print as normal. The print preview approach to report generation used by the ISTS conveniently gives the opportunity to cancel the actual printing of a previewed report by simply pressing the escape key found on keyboards and other devices.

### Default Management

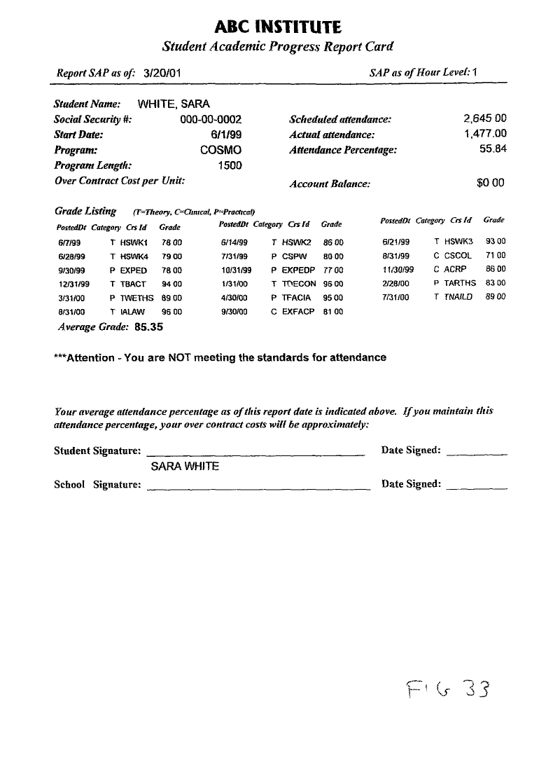

FIG. 23 shows one form of the institutional student tracking system's default management module 360. FIG. 83 shows a schematic view of a flow chart for one embodiment of the default management module 360. The default management module 360 provides a significant amount of capability to administer default management on campus, but also can provide schools who elect to outsource those responsibilities, a convenient tracking system to interface with a default management company. In one embodiment, the default management module 360 contains features such as multiple loan tracking, entrance/exit counseling tracking, repayment status, multiple grace period letters, multiple delinquency letters, additional references database, and CDR calculations.

Efficient use of the ISTS default management module 360 can provide an institution with just what it needs to keep abreast of the school's federal student loan default responsibilities. Continual contact with student borrowers is a must if an institution is to be successful in default prevention. Default prevention also demands an adequate knowledge of federal regulations relative to deferment, forbearance, delinquency and default issues.

Before a user will be in a position to use the system for letter production and loan tracking, student loan accounts must be created. After creating loan accounts, the user will easily be able to review repayment letters due to be sent to students from this main screen. Further, the user can print and post these letters as being sent all from this main default management screen. Projected dates for repayment letters are generated by the system based on a student borrower's repayment status. After receiving a federal student loan, a student will fall under one of several different repayment statuses.

A student's repayment status is in school while he/she remains enrolled on at least a half-time basis. Typically while a student is in school there is no repayment required on certain student loans, for example Stafford student loans. The student will not even incur interest charges on his/her subsidized loan during this period. This in school status will continue until the student ceases to be enrolled on at least a half-time basis. At such time that the students graduates, withdraws or drops below half-time status, they are no longer considered in school, and their grace period begins.

In one example, a student's grace period may last for a period of six months. During this six month grace period, the student is not responsible for repayment similar to the in school status provisions above. At the end of the grace period, a student borrower will enter repayment. Effective default management starts while the student is still in his/her grace period.

Typically, a student's repayment obligations begin at the end of the grace period. It is at this time that students generally become responsible for regular principal and interest payments. Ideally, a student will remain in this repayment status until his/her federal student loan is repaid in full. Effective default management continues strongly during this period of repayment.

### Creating Student Loan Records

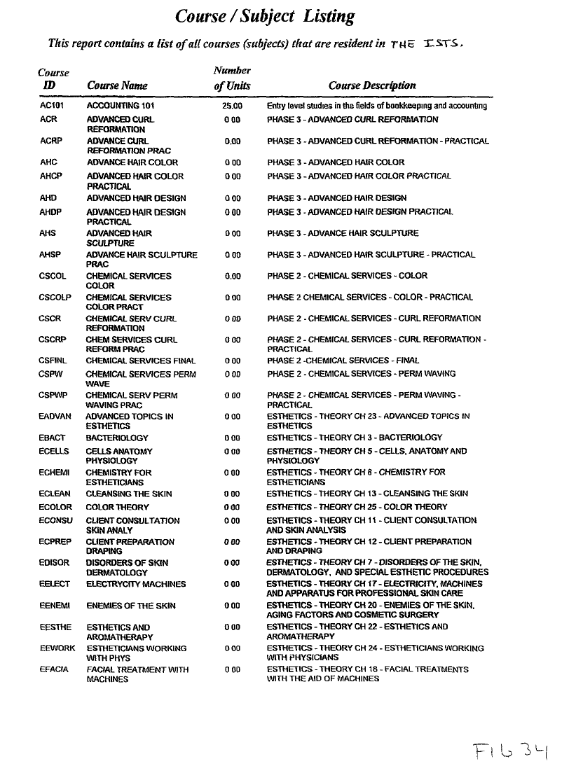

As shown in FIG. 23, in one form default management module 360 has a select an existing student area 362, a preview letter [for testing] button 373, a print letters button 374, and a mark letter as sent to student button 376. A user may use the social security number or student name pick lists 364 and 366 respectively and choose a student by selecting the desired record. The student's record will be displayed as shown in FIG. 24. The student record in the default management module is made up of three sections general student information tab 390, loan information tab 392 and reference tab 394.

### General Student Information

As shown in FIG. 24, in one form the general student information screen 390 contains data necessary to link the related loan and reference information to this specific student record. General student information screen 390 has a social security number field 396, a last and first name fields 398, a current status field 400 and a status due date field 402. Upon selecting a student record from the pick list as described above, the five data elements on the screen are pulled from the main student record in the Student module 186. In one embodiment, the repayment entry date will not be projected unless the student is no longer enrolled at least halftime. In FIG. 24, for example, the student graduated from the institution on Oct. 15, 2000. An institution need not wait until the student has left school to create loan records. Loans can be set up while the student is attending the school.

### Loan Information

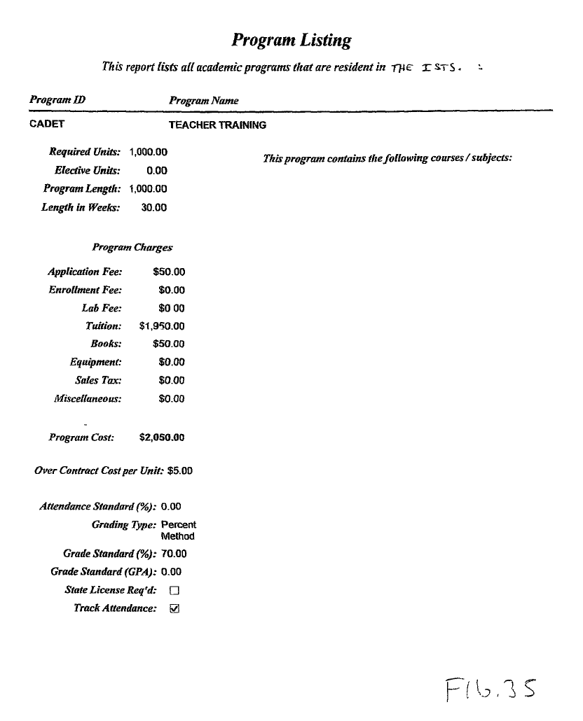

FIG. 25 shows in one form the institutional student tracking system's default management module for a selected student with the loan information tab 404 selected. The user may select the loan information screen 404 to access the students loan records. The loan information screen 404 contains information about each loan a student has obtained at the school. The loan information screen may have a loan number field 406, type of loan field 408, date counseling fields 410, outstanding principle field 412, loan payment status area and fields 414, grace letter date fields 416, letter sent date fields 418 and letter generation date fields as shown in FIG. 25. To create a single loan record, the user may enter the loan number in field 406 and select the loan type from field 408. Loan counseling dates and principal amounts are not required fields but may assist the user for documentation and tracking purposes. Since loan records may be created while the student is attending the school, the repayment status field area 414 defaults to in school with the repayment status date being the system date. If loan records are created after students have already left school, the user may manually set the correct repayment status on the loan record. In one form, the system will automatically calculate repayment entry dates and projected letter dates based on the student's enrollment status and date. For currently enrolled students, these fields will remain blank until the student ceases to be enrolled at least halftime, and the status is modified in the Student module 186. The system will track multiple student loans. To create another loan account, the user would use the record scroll bar 78 as one would to add data in the School module 40.

The loan information screen 404 also contains data in fields 416, 418 and 420 about default management letters. For example, in one embodiment, when a student ceases to be enrolled at least halftime, the student enters his/her grace period. The system will automatically calculate projected dates on when default management letters should be sent. After sending the letters to the students, the system will record when the letters were prepared to document default management activity. A first delinquent letter will be projected when a student's repayment status becomes delinquent. Projected letter dates for second delinquent letters or letters to the student's references are manually created by the school on an as needed basis.

### References

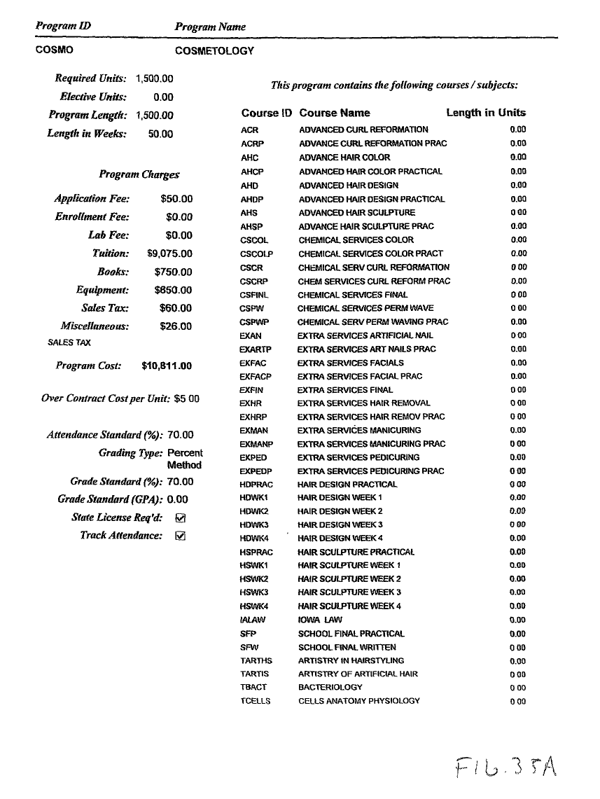

FIG. 26 shows in one form of the institutional student tracking system's default management module for a selected student with the references tab 422 selected. A student borrower's references can be an extremely helpful tool in the default prevention business. Although a reference person has no legal responsibility with regard to actually repaying the student loan, references can help locate a student with whom the institution may have lost contact. Any assistance in contacting student borrowers can possibly help avoid a potential default situation. In one embodiment, the default management module 360 of the ISTS provides space to collect three additional references from student borrowers.

The references screen 442 acts as a storage area for personal information. Reference screen 442 has reference no. 1 area 424, reference no. 2 area 426 and reference no. 3 area 428 which each have fields for entering information about the reference. These fields include name, address and phone information. Of course, as with any of the information screens described herein, screen 442 can contain any type of information field necessary for the particular application. The user may record the relevant information for each of the student borrower's references in the appropriate fields provided.

### Default Prevention Letters

In one embodiment, the ISTS can prepare different default management letters to student borrowers depending on their repayment status. These types may include: grace period letters, repayment letter, delinquent borrower letters, and reference assistance letters.

In one embodiment, when the user prints the first batch of default management letters, the user will discover that the school's name does not appear on the letter. This omission may be designed into the system. Unfortunately, some students do not pay attention to material received from an institution they no longer attend, especially if it regards money owed either to the institution or the government. Even if the student was a model graduate, school correspondence sometimes tends to carry less weight than a more formal, official document. For this and or other reasons, in one form, the default management letters may be designed to be more generic, independent, and official in appearance and text. For even more anonymity, they may be mailed in plain, white, standard #10 window envelopes. The letters have been designed to fit into a window envelope when folded. If the user wants to combine anonymity with an even more official looking document, the user may use plain, brown-paper, window envelopes similar to those used by some governmental agencies.

### Grace Period Letters

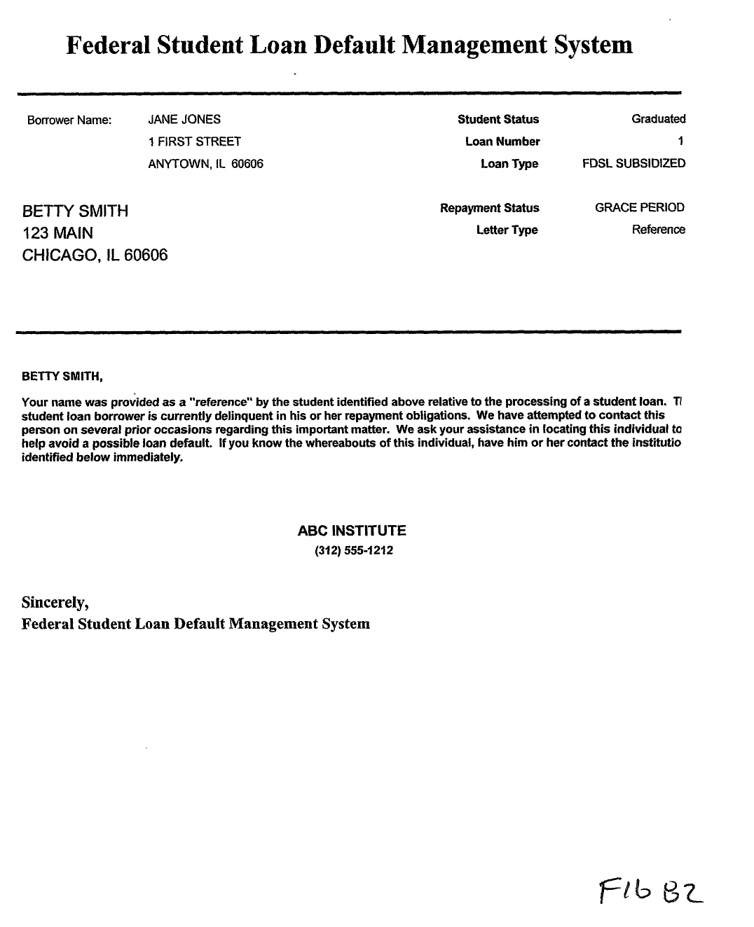

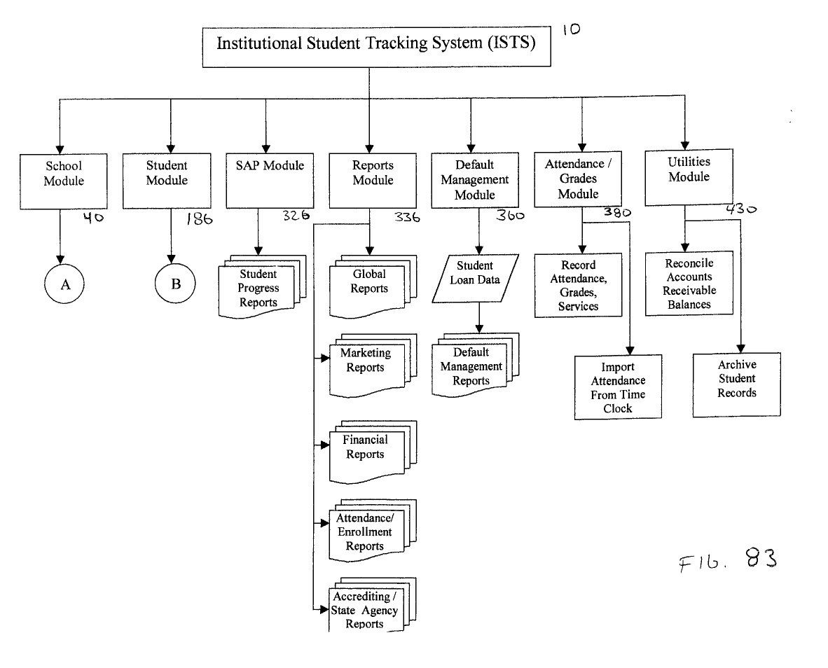

A student's grace period typically begins when he/she is no longer enrolled on at least a half-time basis, and lasts for six months. The system will produce different grace period letters at 30, 90, and 150 day intervals into a students grace period (see for example FIGS. 81 and 82). Each letter may contain modified language as the student more closely reaches repayment on the loan. These letters are designed to keep the student reminded about his/her loan repayment obligations, and encourage the student to contact the financial aid office at the college attended if the student feels he/she may be eligible for a deferment or other repayment adjustments.

### Repayment Letter

If the institution's records are accurate regarding the students dates and status relative to loan repayment, the user will know when the student's first loan repayment is due. 30 days after the loan enters repayment, the system can produce a repayment letter to the student. This letter will also remind the student of repayment obligations, explain that the grace period has expired, and will state that the student should have made at least one payment thus far on the loan. Again, they will be instructed to contact the institution if they are unable to make payments on their loan. The institution can then determine whether a deferment or forbearance is appropriate.

### Delinquent Borrower Letters & Reference Assistance Letters

Despite previous efforts, more aggressive default management tactics must be implemented if a student loan becomes delinquent. Upon notice of this occurrence, a user may modify the student's repayment status to delinquent. The first delinquent borrower letter will be produced. This letter may contain stronger language regarding repayment obligations, along with the consequences of a default. The student will be instructed to immediately contact the school to avoid a default and the resulting consequences. If the students name shows up on another delinquent borrower report, the user can force a second delinquent borrower letter to be produced by entering the current date in the projected letter date area 416 of the 2^{nd} delinquent letter area 420 of the loan information screen 404. In the event delinquency continues, the user may elect to produce letters to the student's references in the same manner described above. In one embodiment, once a student becomes 270 days delinquent, he/she will enter default on the student loan. This default may or may not become part of the cohort default rate (CDR). This is determined based on when the student enters repayment versus when the student defaulted.

### Preparing Default Management Letters

To prepare default management letters, the user may enter the default management module 360 and view the check for past letters due area 368 as shown in FIG. 23. The user can easily review what letters are due to be produced using the information in area 368. Although the current date will most likely be the general choice, the user may modify this to any date. The user can look into the future to see what letters will be produced. However, a student's repayment status may change at any time and this can alter future letters.

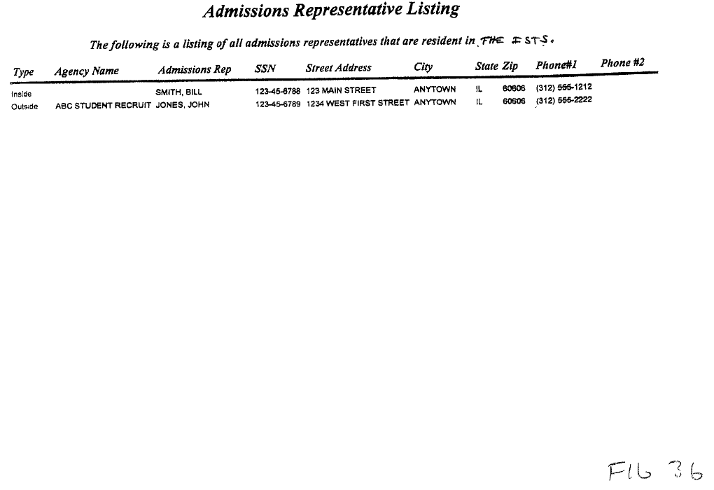

The user may select what letter type the user wants to search, or select all letter types in area 368 to view all the letters. The user would then select the list letters due button 370. The system will display any default management letters due to be sent as of the due date in the review letters to be sent out list box 372 as shown in FIGS. 23 and 27.

As shown in FIG. 27, the information indicates that Jane Jones is scheduled to receive her first two grace period letters relative to her FDSL subsidized loan by the specified letter due date of Jan. 31, 2001. Her first grace letter will be produced in November, and the second in January. A user may view these letters by selecting the print preview button 373. The letters will be produced in a print preview mode. These letters may also be printed by selecting button 374.

After printing the letters, the user may want to mark those letters as being sent to the students. The user would select the mark letters as sent to students button 376 to update the students' records. In one embodiment, failure to update the student record will cause the system to think that letters were not sent, and will result in unnecessary letter duplication.

If for any reason the user wants to reproduce any default management letter that has already been produced and marked as sent, the user may retrieve the student's loan information screen 404, and manually remove the date in the letter sent an area 418 field. The absence of this date will cause the system to reprint any letter whose projected letter date has passed.

### ATTENDANCE/GRADES

The attendance and grades module 380 gives the flexibility to bulk enter attendance and grade information for large numbers of students from a single screen. Using the attendance & grades module 380 the user can not only post attendance and grades, but also view a complete attendance and grade history for any student. And, if the institution records daily attendance with an electronic time clock, importing attendance information from the time clock is done with ease. The ISTS can be customized for an import routine to interface with the specific time clock's software. FIG. 83 shows a schematic view of a flow chart for one embodiment of the attendance/grades module 380.

### Posting Attendance Records

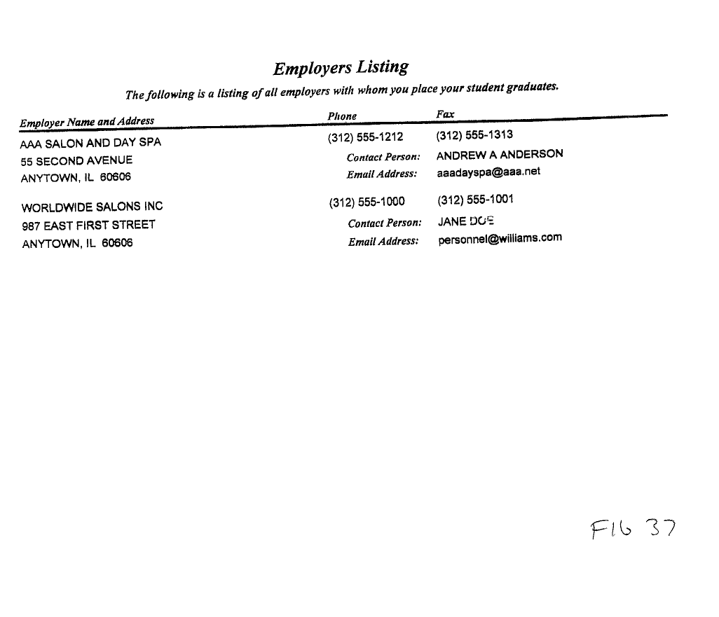

FIG. 28 shows the institutional student tracking system's attendance and grades module with the bulk posting mode tab 382 selected. Posting attendance records is easily performed in the bulk posting mode screen 382 of the attendance & grades module 380.

A user may use the calendar 388 to quickly and easily select the date for the attendance records the user wants to post. Or, if preferred, simply key the date into the date field 390.

The user may select the desired student by clicking on the appropriate record displayed in the select student list box 392. Enter the number of attended hours for each respective category in the fields in area 394. After confirming the total hours value, the user may select the post attendance button 396. The user can view the posting by selecting the view selected student detail tab 384. Hours can be entered daily, weekly, monthly, or in any increment the user chooses. The system will automatically add all postings to arrive at total cumulative hours attended.

After the user has posted the attendance record for the student, the user may select the next student from the select student list box 392, and post the hours for that student. The user may continue until all students' hours have been posted.

### Posting Grade Records

Posting grades from the attendance and grades module 380 is done in a fashion similar to attendance posting. The user may use the calendar 388 to quickly and easily select the date for the grade record selected to post. Or, if preferred, the user-simply key the date into the date field 390. Then the user may select the desired student by clicking on the appropriate record displayed in the select student list box 392. Using the select course box 398, the user may select the desired course/subject pertaining to the grade being posted. The user may select the desired category for the grade being posted by clicking in the appropriate checkbox field 400. Then the grade is entered in field 402. In an alternate embodiment, if the ISTS is set up with percentage based SAP, a percent range field will be displayed. If the ISTS is set up with a GPA SAP standard, a GPA range will be displayed. After the grade value is entered, the user would select the post grade button 404 to record the grade in the student's file.

### Viewing Student Attendance & Grade History

FIG. 29 shows one form of the institutional student tracking system's attendance and grades module with the view selected student detail tab 384 selected. In addition to posting attendance and grades from the attendance and grade module 380, the view selected student detail screen 384 allows the user to obtain a complete history of a particular student's attendance in attendance box 406 and grades in grade box 408.

A user may view a student's attendance and grade history, by selecting a student record from the pick list 392 on the bulk-posting screen 382. After a student record has been selected, the user would select the view selected student detail tab 384. For example, the student's attendance and grade history is displayed as indicated in FIG. 29. When the number of records exceeds the space provided, a vertical scroll bar 410 will appear to aid in navigation through the records. FIG. 29 demonstrates this case with respect to grade records. The attendance records do not yet exceed the space provided. When the student's attendance records exceed the allotted space, a similar scroll bar will appear to the right of the attendance records.

View selected student detail screen 406 is especially helpful when the user is entering attendance and grade records. If uncertain about whether or not a previous attendance or grade record was already posted, the user may review the student's history before proceeding, return to the bulk-posting screen 382 to post a new record, or to select a new student for a review of attendance and grade history.

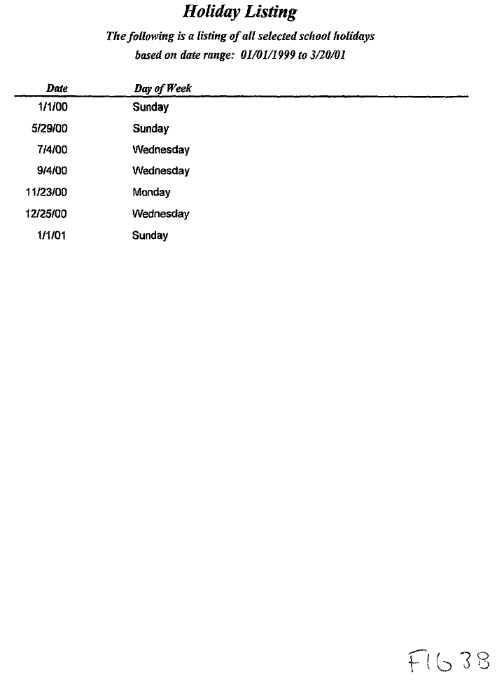

FIG. 30 shows one form of the institutional student tracking system's attendance and grades module with the import attendance from electronic clock tab selected.

As shown in FIG. 30, import attendance from electronic clock screen 380 may have a format type area 412 and import e-clock button 413 as shown in FIG. 30. When a user selects the format type and selects button 413, the time clock import mode screen is accessed.

FIG. 30A shows the Institutional Student Tracking System's time clock import mode screen. The Institutional Student Tracking System enables users to import attendance information from a separate electronic time clock. Users who track student attendance with an electronic time clock simply export the attendance information using the time clock manufacturer's software. This process creates a data file that contains the student's ID or “badge” number along with the attendance information that has been stored within the electronic time clock. This data can be easily imported into the ISTS and provides for a smooth transition of data from the external time clock into the student's permanent record.

Using the Time Clock Import screen 414, users have three options when processing time clock attendance information. The Review Missing Badge Numbers function 416 scans the data file exported by the time clock manufacturer's software, and determines if there are any student ID or badge numbers in the data file that do not match up with the student badge numbers in the ISTS. The user may correct any missing badge number information in the ISTS before importing the time clock information. This ensures an error free import of attendance information.

The Import Data function 418 of the ISTS reads in all attendance information contained in the time clock's export file and posts it to the student's permanent record in the ISTS.

The Exception Report function 420 allows users to print an exception report that lists all data from the original time clock export file that was not properly imported into the ISTS. These exceptions will only occur if there were badge number discrepancies between the ISTS and the time clock's export file that were not corrected by the user prior to importing the time clock data.

### UTILITY MODULE

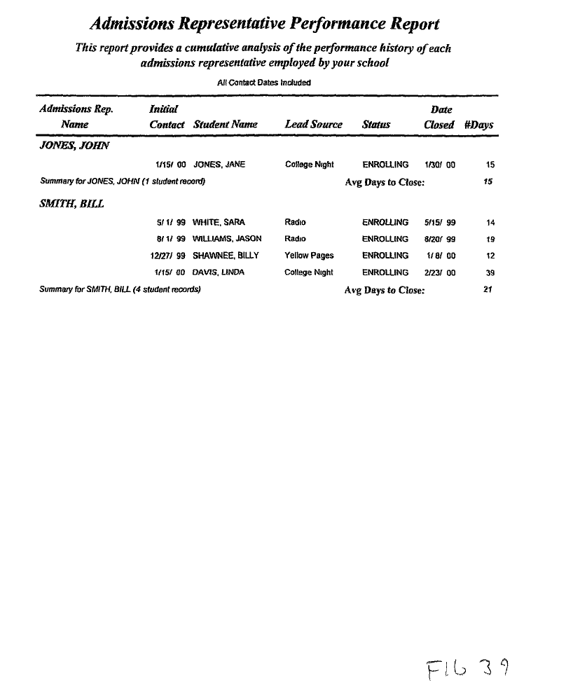

FIG. 31 shows one form of the institutional student tracking system's Utilities module 430. FIG. 83 shows a schematic view of a flow chart for one embodiment of the utilities module 430. The Utilities module 430 provides for modification of student social security numbers. Generally, new student records will be added to the ISTS when the student first contacts the school as a prospective student, or prospect. At this time, a prospect may be unwilling to provide his/her social security number. While using the Student module 186, the user could choose to enter a series of 9's to have the ISTS create a temporary social security number. The Utilities module 430 will easily allow the user to correct the student's social security number when a valid number is obtained.

When the ISTS creates a temporary SSN, it will assign a nine-digit number to the student record. The first temporary SSN created will be 000-00-0001. The next will be 000-00-0002, and so on. To change a temporary SSN to a valid SSN, or to correct an existing SSN that may have been entered incorrectly, the user may enter the Utilities module 430, and using pick list 432, the user selects the student whose SSN the user wants to modify. Ten, the user may enter the correct SSN in the change the SSN to field 433. The user would then select the update selected SSN button 434. Although the SSN has been modified all student data remains unchanged in the ISTS system. Also, as shown in FIG. 31, included are a clean out database button 436 and a balance A/R table button 438 which may be used by the user for their respective functions.

The other utilities options available in the Utilities module 430 are for the use of software developers to aid in troubleshooting and file repair of damaged records. Additional utilities may be added in yet other versions of the ISTS.

### Backing Up Student Records

In one embodiment, the ISTS separates the computer program applications, i.e., the engine from the data files containing school and student data. In the event of a system crash, the user could easily reload the engine from the original ISTS CD. All of the school and student ISTS data may be stored in a file named traxdata.mdb. This file resides in the system in the ISTS folder. This traxdata.mdb file may be backed up on a daily basis to ensure diligent safekeeping of data. If the institution has an automated backup system, for example one that backs up all data during the middle of the night, the ISTS folder may be included in the backup software's instructions. If the institution performs manual backups, the traxdata.mdb file may be included in the backup functions.

### ISTS Term-Based Institutions Version

In yet other embodiments, the ISTS may also provide a version of the software to accommodate institutions that use a term-based academic calendar. The modifications to the ISTS may be in the areas of the institution's term calendar and registration modules, which are not required for the clock hour version of the software.

### Term Calendar

Institutions operating under a term-based academic calendar generally utilize predetermined begin and end dates to each of the respective terms in an academic year. Each term, i.e., quarter, trimester, or semester, is considered an individual enrollment period in which a student registers for various courses or subjects. Using the ISTS term calendar, an institution can establish the dates relevant to its fall, winter, spring, and summer terms. Institutions would then record the courses or subjects for which a student has registered in the registration module. An example of the information retained in the term calendar may be as follows.

| Term ID | Begin Date | End Date |
|---|---|---|
| Fall 2000 | 08/21/2000 | 12/20/2000 |
| Spring 2001 | 01/16/2001 | 05/25/2001 |
| Summer 2001 | 06/04/2001 | 08/17/2001 |
| Fall 2001 | 08/20/2001 | 12/21/2001 |

### Internet Applications

In an alternate embodiment, the ISTS may be provided for access over the Internet or other computer network. For example, one computer network configuration in which the ISTS may be used is where a local area network (LAN) is provided whereby one or more workstations are operatively connected to one or more servers, one or more databases and one or more printers. Whereby, in one configuration, the server(s) may be operatively connected to the Internet or other computer. In yet another configuration, a workstation may be provided whereby the workstation may be operatively connected to the Internet or other computer network. A wide variety of other computer configurations may be utilized to implement the ISTS.

Internet use allows school administrators to view or modify their secure data from any computer with Internet access. Further, a secure student logon feature provides students the ability to login with an ID number giving the student “view only” access to his or her records at the institution. A student may easily view his or her progress in attendance, grades, service performance and accounts receivable at the institution from any computer connected to the Internet.

FIG. 65 shows an alternate embodiment of the institutional student tracking systems attendance and grades module with the view select student detail mode selected. As shown in FIG. 65, the attendance and grade module 439 having a view selected student detail mode button 440 has a student year-to-date attendance in detail area 442, a services year-to-date area 444, and a student year-to-date grades in detail area 446.

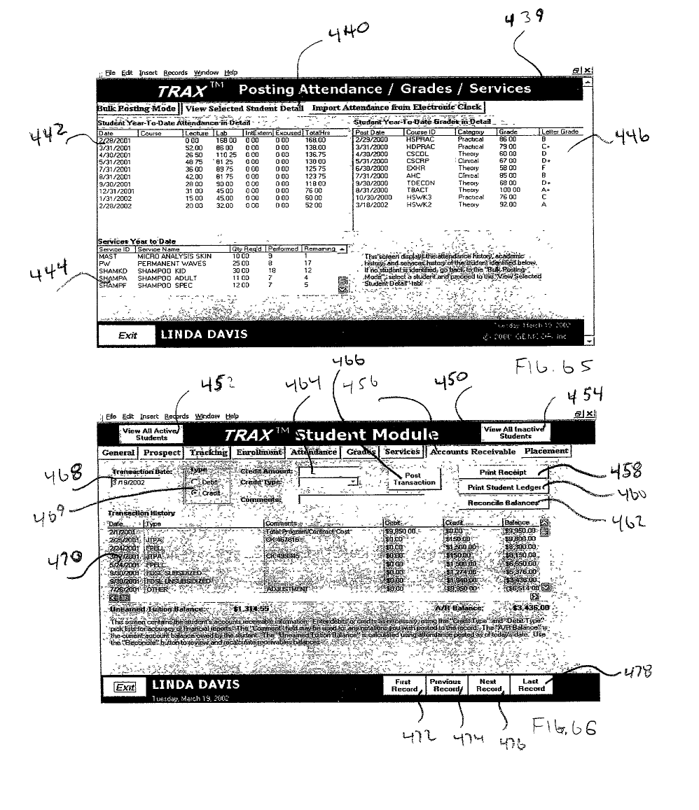

FIG. 66 shows an alternate embodiment of the institutional student tracking systems student module with the accounts receivable mode selected. As shown in FIG. 66 the student module 450 having an accounts receivable button 456 and a view all active students button 452, a view all inactive students button 454, a print receipt button 458, a print student ledger button 460, a reconcile balance button 462, a credit amount and type area 464, a post transaction button 466, a transaction date area 468, a type area 469, a transaction history area 470, a first record button 472, a previous record button 474, a next record button 476, and a last record button 478.

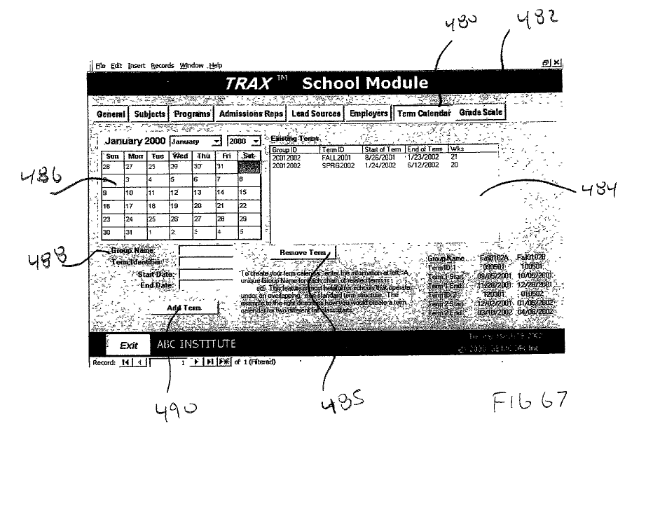

As shown in FIG. 67, in another form of the invention, the Institutional Student Tracking System for term based institutions includes a term calendar function 480 within the School Module 482. With this feature, users may record the institution's term calendar 486. The term calendar 486 is then used in the student registration process allowing users to select a particular term, then proceed with registering classes a student is attempting during that term. Report card functions of the Institutional Student Tracking System for term based institutions generate progress reports on a term specific basis. Also shown in FIG. 67, is a group name and term identifier area 488, an existing terms area 484, a remove term button 485, and an add term button 490.

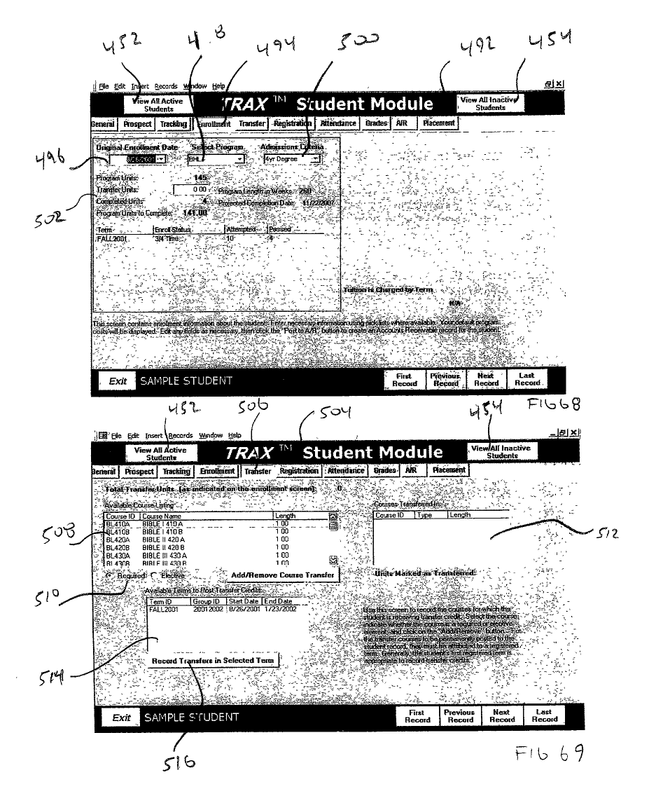

FIG. 68 shows an alternate embodiment of the institutional student tracking system's student module with the enrollment mode selected. As shown in FIG. 68 student module 492 has an enrollment mode 494 having an original enrollment date field 496, a select program area 498, an admissions criteria field 500, a program information area 502 as shown in FIG. 68.

The student enrollment screen 494 of the Institutional Student Tracking System for term based institutions provides for the enrollment of new students in a particular program of study. This screen 494 will report cumulative information regarding the student's progress through the curriculum. Upon completion of each term attended, the enrollment screen will display the cumulative credit hours attempted and completed by the student along with data regarding the number of credits remaining to be completed to meet graduation requirements.

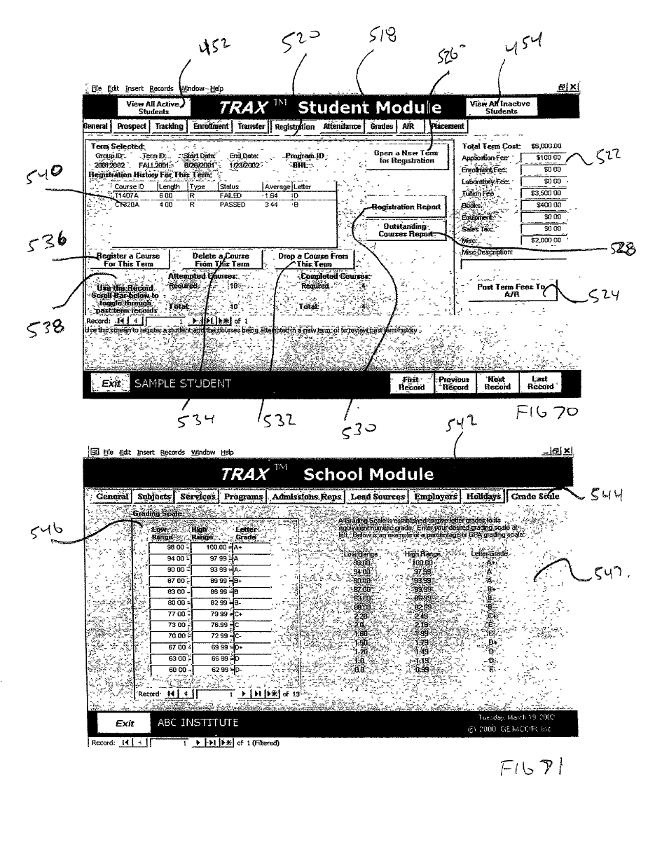

FIG. 69 shows an alternate embodiment of the institutional student tracking system's student module with the transfer mode selected. As shown in FIG. 69 student module having transfer mode 506 has an available course listing area 508, a required or elective selection area 510, a courses transferred area 512, an available terms to post transfer credits area 514, and a record transfers in selected term button 516.

The transfer credit screen 506 of the Institutional Student Tracking System for term based institutions allows the user to record any courses that an enrolling student is transferring in from another institution. Frequently students complete courses at one institution that are transferable to a future institution. This feature of the system records those transfer credits and eliminates the necessity for the student to complete those courses at the current institution. Transfer credits are included in a determination of graduation requirements completed, but excluded from GPA scores at the current institution.

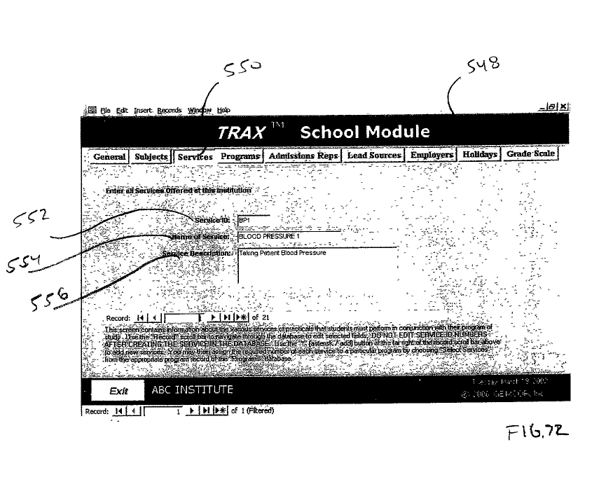

FIG. 70 shows an alternate embodiment of the institutional student tracking system's student module with the registration mode selected. As shown in FIG. 70, registration mode 520 has a total term cost area with related fields 522, a post term fees to A/R button 524, an open a new term for registration button 526, an outstanding courses report 520, an outstanding course button 528, a registration report button 530, a drop a course from this term button 532, a delete a course from this term button 534, a register a course for this term button 536, an attempted and completed courses area 538, a registration history for this term area 540.

The registration screen 520 of the Institutional Student Tracking System for term based institutions allows users to register a student's attempted courses for a particular term, e.g., semester, trimester, or quarter. This screen also provides for the adding or dropping of a selected course during the institutions “drop/add” period and a record of the charges incurred by the student for that term's courses, which may be automatically posted to the student's accounts receivable record with the institution. Upon completion of the term and the posting of all examination scores, the registration screen will be automatically updated to indicate whether or not an attempted course was passed or failed along with the letter grade for each course attempted within that term, e.g., A, B+, C−, etc. Courses passed by the student are then automatically recorded against graduation requirements while courses failed will continually appear as uncompleted until the student successfully completes the course.

The Institutional Student Tracking System for term based institutions is also designed for use over the Internet by institutional administrators and students. As in the clock hour version of the system, students may login to their account and gain “view only” access to their records with the institution from any computer connected to the Internet.

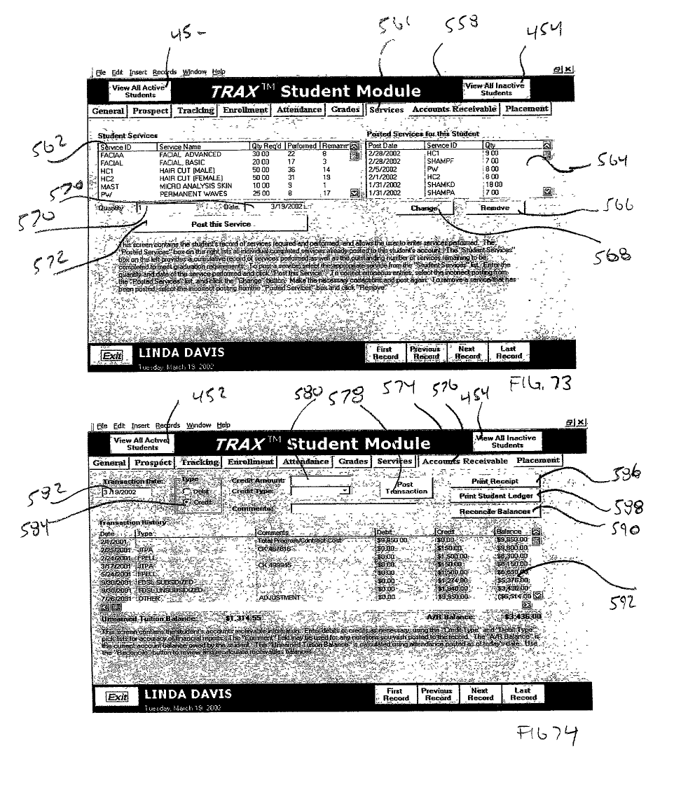

FIG. 71 shows an alternate embodiment of the institutional student tracking system school module with the grade scale mode selected. As shown in FIG. 71 school module 42 has a grade scale mode 544 having a grading scale area with associated fields 546 and a grading scale identification area 547 substantially as shown in FIG. 71.

The Institutional Student Tracking System is equipped with a grade scale which allows the user to record letter grades for student examinations as well as the examination's percentage or GPA score equivalent. By creating the grade scale in the School Module, all future grades posted to student accounts will be automatically recorded with either percentage or GPA, and letter grade equivalents. Future report cards issued to the student will conveniently average all grades within a particular subject matter to provide the student with a single letter grade for the subject attempted by the student.

FIG. 72 shows an alternate embodiment of the institutional student tracking system's school module with the services mode selected. As shown in FIG. 72 services mode 550 has a service ID area 552, a name of service area 554 and a service description area 556.

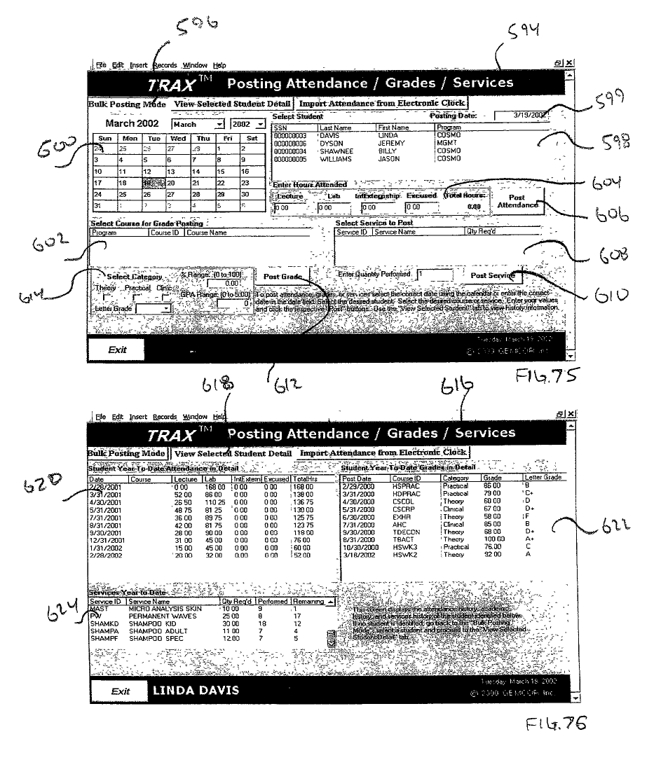

FIG. 73 shows an alternate embodiment of the institutional student tracking system's student module with the service mode selected as shown in FIG. 73, services mode 560 has a student services area 562, a posted services for this student area 564, a remove button 566, a change button 568, a quantity and date field areas 570 and a post this service button 572.

The Institutional Student Tracking System includes a services mode 550 within the School Module. This feature is useful for situations in which a required number of functions or services must be performed to meet graduation requirements in a particular program of study. Examples include programs in cosmetology arts and sciences wherein a student must perform a specified number of haircuts, color applications, etc., in order to meet graduation requirements. The user would record services performed by students, and the Institutional Student Tracking System will provide reports identifying the services performed to date as well as the services remaining to be performed to achieve successful completion of the academic program.

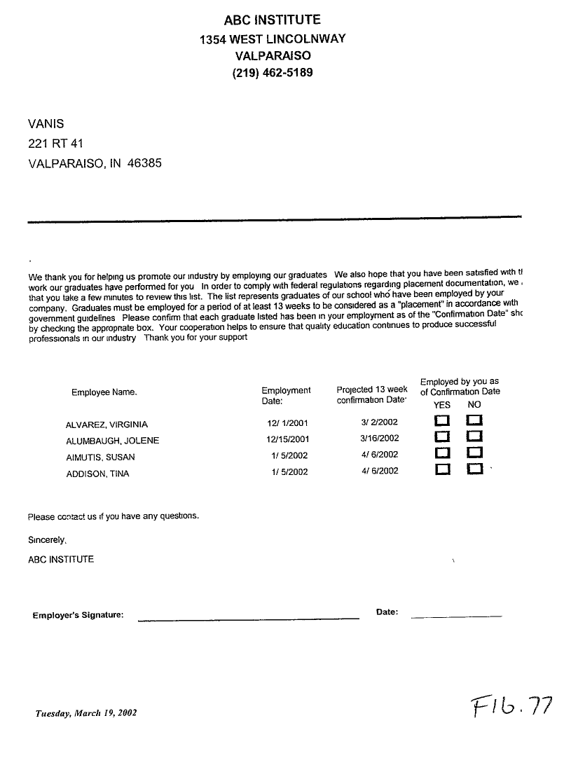

FIG. 74 shows an alternate embodiment of the institutional student tracking system's student module with the accounts receivable mode selected. In FIG. 74 as shown the accounts receivable mode 576 has a post transaction button 578, a credit amount and type fields 580, a transaction date field area 582, a credit or debit type area 584, a print receipt button 586, a print student ledger button 588, a reconcile balances button 590 and a transaction history area 592.

The Student Module of the Institutional Student Tracking System includes an accounts receivable mode 576 that tracks charges to a student's account, credits received on a student's account and an ongoing balance of charges owed. An easy to use receipt feature allows the user to select any entry in a student's account and immediately print a receipt for the student on the selected transaction.

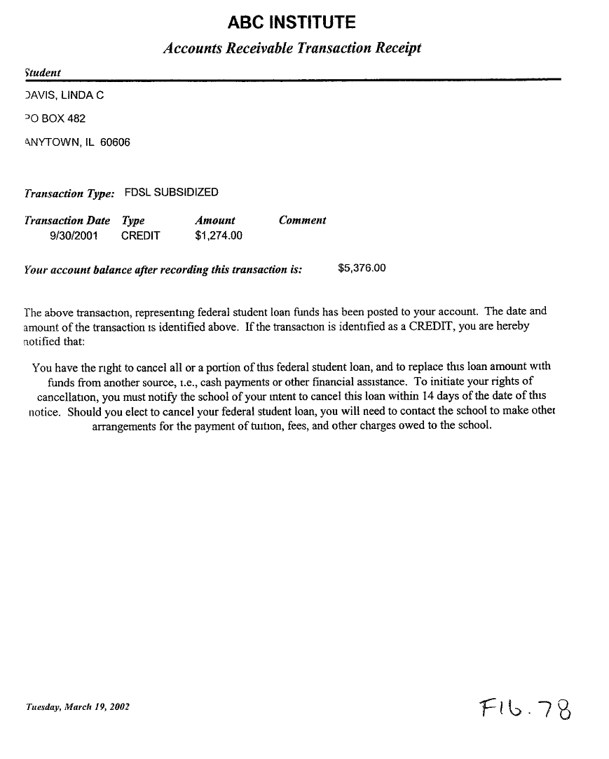

FIG. 75 shows an alternate embodiment of the institutional student tracking systems attendance and grade module with a bulk posting mode selected. As shown in FIG. 75 bulk posting mode 596 has a select student area 598, a posting date field 599, a calendar area 600, a select courses for grade posting area 602, an enter hours attended and related fields area 604, a post attendance button 606, a select service to post area 608, a post service button 610, a post grade button 612, and a select category area and related fields 614.

The Bulk Posting mode 576 of the Institutional Student Tracking System allows institutions to record attendance, grades, and services performed by students from a single easy to access screen 596. Using this feature, the user may conveniently record all three elements for a particular student from a single screen 596 image thus reducing data entry time and administrative effort.

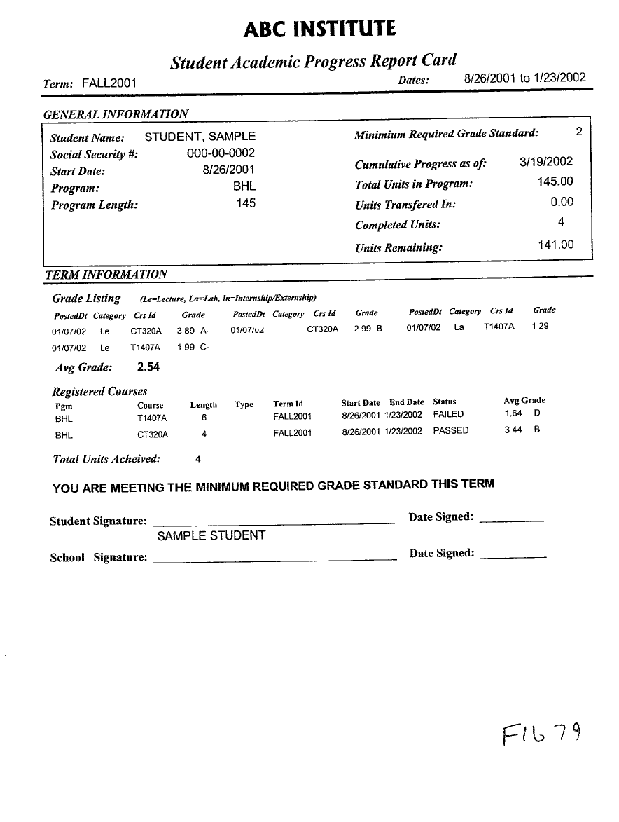

FIG. 76 shows an alternate embodiment of the institutional student tracking system's attendance and grades module with the view select student detail mode selected. As shown in FIG. 76 the view selected student detail mode 618 has a student year-to-date attendance and detail area 620, a student year-to-date grades in detail area 622, and a services year-to-date area 624. The View Student screen provides users with an at a glance image of a student's attendance, grades, and service history on a single screen image.

FIG. 86 shows one embodiment of a computer network configuration in which the ISTS 10 may be used. As shown in FIG. 86, a local area network (LAN 700 may be provided whereby one or more workstations 702 are operatively connected to one or more servers 704, one or more databases 706 or 708 and one or more printers 710. Whereby, in an alternate embodiment, the server(s) 704 may be operatively connected to the Internet or world wide computer network 712 or other computer network. In an alternate embodiment, a work station 714 may be provided whereby the work station 714 may be operatively connected to the Internet 712 or other computer network. A wide variety of other computer configurations may be utilized to implement the invention.

Specific embodiments of novel methods and apparatus for construction of novel computer storage carts according to the present invention have been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention any and all modifications, variations, or equivalents that fall within the true spirit and scope of the basic underlying principles disclosed and claims herein.

What is claimed is:

1. A method of tracking student information for a plurality of students, the method comprising the steps of:
providing in an electronic system a plurality of modules that interact with each other to manage student information;
receiving information for at least some of the students; and
generating at least one report based on the student information.

2. The method of claim 1 wherein the plurality of modules comprises a school module, a student module, a satisfactory academic progress module, a report module, a default management module, an attendance and grades module and a utilities module.

3. The method of claim 1 further comprising the step of printing a report based on the student information for a selected student.

4. The method of claim 1 further comprising the step of making the student information available to multiple users of the electronic system.

5. The method of claim 1 further comprising the step of making the student information available to users over a world wide computer network.

6. The method of claim 1 further comprising the step of allowing select users to edit the student information.

7. The method of claim 1 further comprising the step of allowing users to specify the information contained in at least one report.

8. The method of claim 1 further comprising the step of making select student information available to students over a world wide computer network.

9. The method of claim 1 further comprising the step of allowing a user to view a generated report before the report is printed.

10. A system for tracking student information comprising:
a means through which a user can enter student information;
a plurality of modules that manage the student information;
a means for storing the student information; and
a means for generating at least one report based on the student information.

11. The system of claim 10 wherein the plurality of modules comprises a school module, a student module, a satisfactory academic progress module, a report module, a default management module, an attendance and grades module and a utilities module.

12. The system of claim 10 further comprising a means for making the student information available to multiple users of the system.

13. The system of claim 10 further comprising a means for making the student information available to users over a world wide computer network.

14. The system of claim 10 further comprising a means for allowing select users to edit the student information.

15. The system of claim 10 further comprising a means for making select student information available to students over a world wide computer network.

16. A system for managing student information comprising:
a plurality of modules that manage the student information;
memory which stores the student information in the form of a student database;
a processor which accesses the student database and processes the student information to provide display data to permit display of student information organized in part as defined by a user of the system;
a display coupled to the processor to provide displaying of student information;
an input device which permits inputting of the student information; and
an output port for output of a report generated by the processor.

17. The system of claim 16 further comprising a means for making the student information available to multiple users of the system.

18. The system of claim 16 further comprising a means for making the student information available to users over a world wide computer network.

19. The system of claim 16 further comprising a means for allowing select users to edit the student information.

20. The system of claim 16 further comprising a means for making select student information available to students over a world wide computer network.
